(19) United States
(12) Patent Application Publication
(10) Pub. No.: US 2004/0090398 A1
(43) Pub. Date: May 13, 2004

(54) Display

(75) Inventors: Yukihisa Takeuchi, Nishikamo-Gun (JP); Tsutomu Nanataki, Toyoake-City (JP); Iwao Ohwada, Nagoya-City (JP); Nobuyuki Kokune, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/699,186

(22) Filed: Oct. 31, 2003

(30) Foreign Application Priority Data
Nov. 5, 2002 (JP) 2002-321564
Aug. 25, 2003 (JP) 2003-300205

(51) Int. Cl. G09G 3/20; G09G 3/22

(52) U.S. Cl. 345/75.2

(57) ABSTRACT

A display comprises a housing having a mother board, an outer frame, and a transparent plate, and a plurality of modules each having a plurality of electron emitters arrayed on a module board. The modules are disposed as a matrix on the mother board, and sealed in vacuum in the housing. One or more spacers may be interposed between the mother board and the transparent plate to keep a gap at a predetermined distance between the mother board and the transparent plate.

### BACKGROUND OF THE INVENTION

1. Field of the Invention

The present invention relates to a display having a number of electron emitters.

2. Description of the Related Art

Electron emitters having drive electrodes and ground electrodes have been finding use in various applications such as field emission displays (FEDs) and backlight units (see, for example, documents 1 through 8 enumerated below). In an FED, a plurality of electron emitters are arranged in a two-dimensional array, and a plurality of phosphors are positioned at predetermined intervals in association with the respective electron emitters.

Document 1:

Japanese laid-open patent publication No. 1-311533

Document 2:

Japanese laid-open patent publication No. 7-147131

Document 3:

Japanese laid-open patent publication No. 2000-285801

Document 4:

Japanese patent publication No. 46-20944

Document 5:

Japanese patent publication No. 44-26125

Document 6:

Yasuoka, Ishii “Pulsed electron source using ferroelectric cathode”, J. Appl. Phys., Vol. 68, No. 5, p. 546-550 (1999)

Document 7:

V. F. Puchkarev, G. A. Mesyats, “On the mechanism of emission from the ferroelectric ceramic cathode”, J. Appl. Phys., Vol. 78. No. 9, 1 Nov., 1995, p. 5633-5637

Document 8:

H. Riege, “Electron emission from ferroelectrics—a review”, Nucl. Instr. And Meth. A340, p. 80-89 (1994)

However, there has not been an established technology for the structure of displays which employ conventional general electron emitters as disclosed in the above documents 1 through 8. In particular, no technology is available at present for making such displays larger in size and lower in cost.

### SUMMARY OF THE INVENTION

It is therefore an object of the present invention to provide a display having a structure that is suitable for achieving a larger screen size at a lower cost.

According to a first aspect of the present invention, there is provided a display comprising a housing having a first board, and a plurality of modules each having a plurality of electron emitters arrayed on a second board, the modules being arrayed on the first board, at least the modules being electrically connected to each other, the modules being sealed in vacuum in the housing.

With the arrangement of the first aspect of the present invention, a plurality of electron emitters are arrayed on a second board, making up a module, and a plurality of such modules are arrayed on a first board. The display thus arranged can easily provide a large screen size.

According to a second aspect of the present invention, there is provided a display comprising a housing having a first board, and a plurality of chips each having an electron emitter, the chips being arrayed on the first board, at least the chips being electrically connected to each other, the chips being sealed in vacuum in the housing.

With the arrangement of the second aspect of the present invention, a chip having an electron emitter is fabricated, and a plurality of such chips are arrayed on a first board. The display thus arranged can easily provide a large screen size.

According to a third aspect of the present invention, there is provided a display comprising a housing having a first board, and a plurality of electron emitters directly formed as a film on the first board, the electron emitters being sealed in vacuum in the housing.

With the arrangement of the third aspect of the present invention, a plurality of electron emitters are directly formed as a film on a first board. The display thus arranged can be manufactured simply at a low cost.

In the above first through third aspects of the invention, the housing may have a transparent plate facing the first board, the transparent plate supporting, on a surface thereof facing the first board, an electrode for producing an electric field between the electrode and the electron emitters, and a phosphor disposed on the electrode, and wherein electrons emitted from the electron emitters are brought into collision with the phosphor to excite the phosphor for thereby emitting light therefrom.

According to a fourth aspect of the present invention, there is provided a display comprising a housing having a first board, and a plurality of vacuum-sealed modules each having a plurality of electron emitters arrayed on a second board and sealed in vacuum, the vacuum-sealed modules being arrayed on the first board, at least the vacuum-sealed modules being electrically connected to each other.

In the fourth aspect of the present invention, each of the vacuum-sealed modules may have a transparent plate facing the second board, the transparent plate supporting, on a surface thereof facing the second board, an electrode for producing an electric field between the electrode and the electron emitters, and a phosphor disposed on the electrode, and wherein electrons emitted from the electron emitters are brought into collision with the phosphor to excite the phosphor for thereby emitting light therefrom.

In the displays according to the first through fourth aspects of the present invention, each of the electron emitters should preferably be constructed as follows: The electron emitter comprises an emitter section made of a dielectric material, and a first electrode and a second electrode which are disposed in contact with the emitter section, and wherein when a drive voltage is applied between the first electrode and the second electrode, at least a portion of the emitter section has a polarization reversed or changed to emit electrons therefrom.

Operation of each of the electron emitters will be described below. When a drive voltage is applied between the first electrode and the second electrode, at least a portion of the emitter section has its polarization reversed or changed, emitting electrons from a region in the vicinity of the first electrode which has a lower potential than the second electrode. Because of the reversed or changed polarization, a locally concentrated electric field is produced in the first electrode and the positive poles of dipole moments in the vicinity of the first electrode, causing the first electrode to emit primary electrons. The primary electrons emitted from the first electrode impinge upon the material of the emitter section, causing the material of the emitter section to emit secondary electrons.

If the electron emitter section has a triple point that is made up of the first electrode, the emitter section, and a vacuum atmosphere, then primary electrons are emitted from the portion of the first electrode in the vicinity of the triple point, and the primary electrons emitted from the triple point impinge upon the emitter section, causing the emitter section to emit secondary electrons. If the thickness of the first electrode is extremely small (up to 10 nm), then electrons are discharged from the interface between the first electrode and the emitter section.

The secondary electrons referred to above include solid-state electrons that have jumped out of the emitter section under the energy produced by coulomb collision with primary electrons, Auger electrons, and electrons (reflected electrons) which are actually primary electrons that are scattered near the surface of the emitter section.

Because electrons are emitted by the above principles, the electron emitter can stably emit electrons two billion times or more, and is hence highly practical. Since the amount of emitted electrons increases in substantial proportion to the amplitude of the drive voltage that is applied between the first electrode and the second electrode, it is easy to control the amount of emitted electrons.

According to a first arrangement of the present invention, the first electrode and the second electrode are disposed in contact with a principal surface of the emitter section, with a slit defined between the first electrode and the second electrode, the emitter section being partly exposed through the slit.

If the slit has a width d and a voltage Vak is applied between the first electrode and the second electrode, then the polarization of the emitter section is reversed or changed in an electric field E expressed by E=Vak/d, which is applied to the material of the emitter section.

According to a second arrangement of the present invention, the first electrode is disposed on a first surface of the emitter section, and the second electrode is disposed on a second surface of the emitter section.

If the material of the emitter section sandwiched between the first electrode and the second electrode has a thickness h and a voltage Vak is applied between the first electrode and the second electrode, then the polarization of the emitter section is reversed or changed in an electric field E expressed by E=Vak/h, which is applied to the material of the emitter section.

In the above electron emitters, the emitter section may be made of at least one of a piezoelectric material, an electrostrictive material, or an anti-ferroelectric material.

The above displays according to the present invention can easily provide a larger screen size and be manufactured at a lower cost.

The above and other objects, features, and advantages of the present invention will become more apparent from the following description when taken in conjunction with the accompanying drawings in which preferred embodiments of the present invention are shown by way of illustrative example.

### DESCRIPTION OF THE DRAWINGS

FIG. 1 is a cross-sectional view of an electron emitter according to a first embodiment of the present invention;

FIG. 2 is a plan view of electrodes of the electron emitter according to the first embodiment of the present invention;

FIG. 3 is a diagram showing the waveform of a drive voltage that is applied between a cathode electrode and an anode electrode of the electron emitter according to the first embodiment of the present invention;

FIG. 4 is an enlarged fragmentary cross-sectional view showing the manner in which the electron emitter according to the first embodiment operates when a first voltage is applied between the cathode electrode and the anode electrode;

FIG. 5A is an enlarged fragmentary cross-sectional view showing the manner in which primary electrons are emitted when a second-voltage is applied between the cathode electrode and the anode electrode;

FIG. 5B is an enlarged fragmentary cross-sectional view illustrative of the principles by which secondary electrons are emitted based on the emitted primary electrons;

FIG. 6 is a diagram showing the relationship between the emitted energy of the secondary electrons and the amount of emitted secondary electrons;

FIG. 7 is a cross-sectional view of a first modification of the electron emitter according to the first embodiment of the present invention;

FIG. 8 is a cross-sectional view of an electron emitter according to a second embodiment of the present invention;

FIG. 9 is a plan view of electrodes of the electron emitter according to the second embodiment of the present invention;

FIG. 10 is a plan view of electrodes of a first modification of the electron emitter according to the second embodiment of the present invention;

FIG. 11 is a plan view of electrodes of a second modification of the electron emitter according to the second embodiment of the present invention;

FIG. 12 is an enlarged fragmentary cross-sectional view showing the manner in which the electron emitter according to the second embodiment of the present invention operates when a first voltage is applied between a cathode electrode and an anode electrode thereof;

FIG. 13 is an enlarged fragmentary cross-sectional view showing the manner in which electrons are emitted when a second voltage is applied between the cathode electrode and the anode electrode;

FIG. 14 is an enlarged fragmentary cross-sectional view showing the manner in which the emission of electrons is self-stopped due to a negative charge buildup on the surface of an emitter section;

FIG. 15A is a diagram showing the waveform of a drive voltage;

FIG. 15B is a diagram showing the waveform of a change in a voltage applied between the cathode electrode and the anode electrode of the electron emitter according to the second embodiment of the present invention;

FIG. 16 is a schematic perspective view of a display according to a first embodiment of the present invention;

FIG. 17 is a fragmentary vertical cross-sectional view of the display according to the first embodiment of the present invention;

FIG. 18 is a plan view, partly omitted from illustration, of a module according to a first specific example;

FIG. 19 is a plan view, partly omitted from illustration, of a module according to a second specific example;

FIG. 20 is a view showing a pattern of connections between anode electrodes and row selection lines, and connections between cathode electrodes and signal lines;

FIG. 21 is a view showing another pattern of connections between anode electrodes and row selection lines, and connections between cathode electrodes and signal lines;

FIG. 22 is a plan view, partly omitted from illustration, of a module according to a third specific example;

FIG. 23 is a plan view, partly omitted from illustration, of a module according to a fourth specific example;

FIG. 24 is a plan view, partly omitted from illustration, of a module according to a fifth specific example;

FIG. 25 is a plan view, partly omitted from illustration, of a module according to a sixth specific example;

FIG. 26 is an enlarged fragmentary perspective view of the module according to the sixth specific example;

FIG. 27 is a fragmentary cross-sectional view showing a pattern of interconnections of the display according to the first embodiment of the present invention;

FIG. 28 is a block diagram of a peripheral circuit of the display according to the first embodiment of the present invention;

FIG. 29A is a diagram showing the waveform of a selection signal supplied to a row selection line;

FIG. 29B is a diagram showing the waveform of a data signal supplied to a signal line, particularly a data signal which is ON;

FIG. 29C is a diagram showing the waveform of a drive voltage that is applied between a cathode electrode and an anode electrode;

FIG. 30A is a diagram showing the waveform of a selection signal supplied to a row selection line;

FIG. 30B is a diagram showing the waveform of a data signal supplied to a signal line, particularly a data signal which is OFF;

FIG. 30C is a diagram showing the waveform of a drive voltage that is applied between a cathode electrode and an anode electrode;

FIG. 31 is a fragmentary cross-sectional view showing another pattern of interconnections of the display according to the first embodiment of the present invention;

FIG. 32 is a fragmentary cross-sectional view showing still another pattern of interconnections of the display according to the first embodiment of the present invention;

FIG. 33 is a plan view, partly omitted from illustration, of a display according to a second embodiment of the present invention;

FIG. 34 is a vertical cross-sectional view, partly omitted from illustration, of the display according to the second embodiment of the present invention;

FIG. 35 is a plan view, partly omitted from illustration, of a display according to a third embodiment of the present invention;

FIG. 36 is a fragmentary vertical cross-sectional view of the display according to the third embodiment of the present invention;

FIG. 37 is a fragmentary perspective view of a first modification of the display according to the third embodiment of the present invention;

FIG. 38 is a fragmentary plan view of the first modification of the display according to the third embodiment of the present invention;

FIG. 39 is a plan view, partly omitted from illustration, of a second modification of the display according to the third embodiment of the present invention;

FIG. 40 is a plan view, partly omitted from illustration, of a third modification of the display according to the third embodiment of the present invention;

FIG. 41 is a plan view, partly omitted from illustration, of a fourth modification of the display according to the third embodiment of the present invention;

FIG. 42 is a plan view, partly omitted from illustration, of a fifth modification of the display according to the third embodiment of the present invention;

FIG. 43 is a fragmentary vertical cross-sectional view of a display according to a fourth embodiment of the present invention;

FIG. 44 is a fragmentary cross-sectional view showing a pattern of interconnections of the display according to the fourth embodiment of the present invention;

FIG. 45 is a fragmentary plan view illustrative of a pixel pitch of the display according to the fourth embodiment of the present invention;

FIG. 46 is a plan view, partly in cross section, of a first modification of the electron emitter according to the first embodiment of the present invention;

FIG. 47 is a cross-sectional view taken along line XXXXVII-XXXXVII of FIG. 46;

FIG. 48 is a plan view, partly in cross section, of a second modification of the electron emitter according to the first embodiment of the present invention; and

FIG. 49 is a cross-sectional view taken along line XXXXIX-XXXXIX of FIG. 48.

### DESCRIPTION OF THE PREFERRED EMBODIMENTS

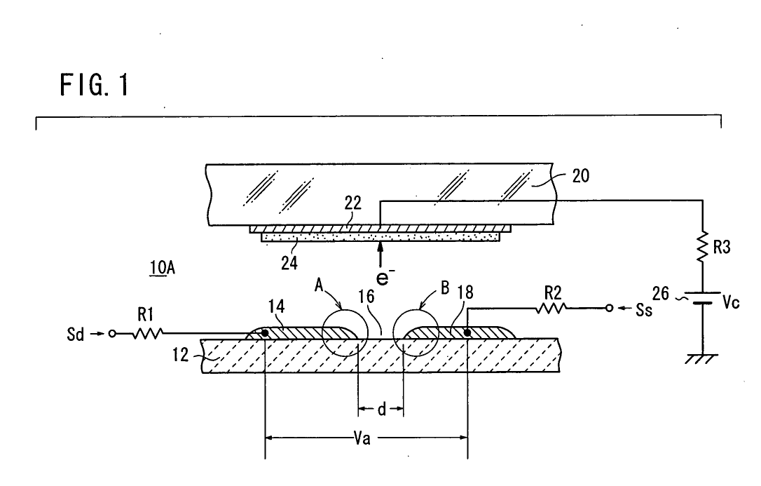

Displays according to various embodiments of the present invention will be described below with reference to FIGS. 1 through 49.

First, structural details of an electron emitter that can be incorporated in the displays according to the embodiments of the present invention, and the principles by which the electron emitter operates will be described below with reference to FIGS. 1 through 15B.

As shown in FIG. 1, an electron emitter 10A according to a first embodiment of the present invention has an emitter section 12, a first electrode (cathode electrode) 14 formed on one surface of the emitter section 12, and a second electrode (anode electrode) 18 formed on the same surface of the emitter section 12 with a slit 16 defined between the cathode electrode 14 and the anode electrode 18. The cathode electrode 14 is supplied with a pixel or data signal Sd from a signal line, as descried later on, through a current-limiting resistor R1, and the anode electrode 18 is supplied with a selection signal Ss from a row selection line through a current-limiting resistor R2. A drive voltage Va based on the data signal Sd and the selection signal Ss is applied between the cathode electrode 14 and the anode electrode 18.

If the electron emitter 10A is used as a dot or pixel of a display, then a transparent plate 20 of glass or acrylic resin is disposed above the cathode electrode 14. A collector electrode 22 which comprises a transparent electrode is disposed on the reverse surface of the transparent plate 20, which faces the cathode electrode 14. The surface facing the cathode electrode 14 of the collector electrode 22 is coated with a phosphor 24. A bias voltage source 26 for applying a bias voltage Vc is connected to the collector electrode 22 through a resistor R3.

The electron emitter 10A is placed in a vacuum. As shown in FIG. 1, the electron emitter 10A has electric field concentration points A, B. The point A can be defined as a triple point where the cathode electrode 14, the emitter section 12, and the vacuum are present at one point. The point B can also be defined as a triple point where the anode electrode 18, the emitter section 12, and the vacuum are present at one point.

The vacuum level in the atmosphere in which the electron emitter 10A is placed should preferably in the range from 10² to 10⁻⁶ Pa, and more preferably in the range from 10⁻³ to 10⁻⁵ Pa.

The reasons for the above range are as follows. (1) In a low vacuum, many gas molecules would be present in the atmosphere, and a plasma would easily be generated. If an intensive amount of plasma is generated, many positive ions of the plasma would impinge on, and therefore damage the cathode electrode 14. (2) Emitted electrons would impinge on gas molecules before reaching the collector electrode 22, therefore slowing the gas molecules. The phosphor 24 would not sufficiently be excited for the electrons are not sufficiently accelerated by the collector potential (Vc).

On the other hand, in a high vacuum, though electrons would be easily emitted from the electric field concentration points A and B, structural body supports and vacuum seals need to be large in size, posing disadvantages on efforts to minimize the size of the electron emitter.

The magnitude of the width d of the slit 16 between the cathode electrode 14 and the anode electrode 18 will be described below. If the voltage between the cathode electrode 14 and the anode electrode 18 (the voltage appearing between the cathode electrode 14 and the anode electrode 18 when a voltage Va is applied between the cathode electrode 14 and the anode electrode 18) is Vak, then the width d should preferably be set in order to reverse or change the polarization in an electric field E expressed by E=Vak/d. That is, as the width d of the slit 16 is smaller, the polarization can be reversed or changed at a lower voltage, so that the electron emitter is capable of emitting electrons at a lower drive voltage less than 100 V. The emitter section 12 should preferably have a dielectric breakdown voltage of at least 10 kV/mm. In the present embodiment, if the width d of the slit 16 is 70 μm, then even when a drive voltage of −100 V is applied between the cathode electrode 14 and the anode electrode 18, the portion of the emitter section 12 which is exposed through the slit 16 will not lead to a dielectric breakdown.

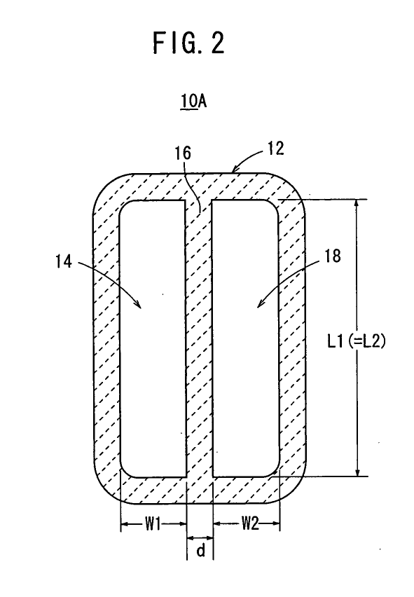

As shown in FIG. 2, the cathode electrode 14 has a width W1 of 2 mm, a length L1 of 5 mm, and a thickness which may be 20 μm or less, preferably 5 μm or less.

The anode electrode 18 has a thickness which may be 20 μm or less, preferably 5 μm or less. As shown in FIG. 2, the anode electrode 18 has a width W2 of 2 mm and a length L2 of 5 mm, as the cathode electrode 14.

In the electron emitter 10A according to the present embodiment, the width d of the slit 16 between the cathode electrode 14 and the anode electrode 18 is 70 μm.

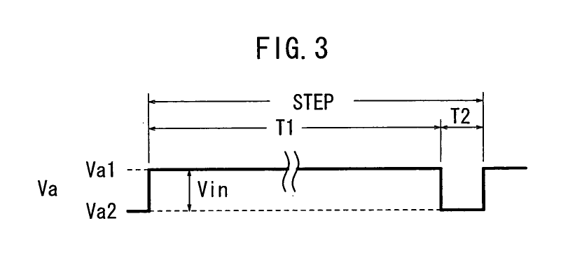

The principles by which electrons are emitted from the electron emitter 10A will be described below with reference to FIGS. 1, and 3 through 6. As shown in FIG. 3, the drive voltage Va applied between the cathode electrode 14 and the anode electrode 18 has a waveform in the form a step, which is repeated, including a period in which a first voltage Va1 is outputted (preparatory period T1) and a period in which a second voltage Va2 is outputted (electron emission period T2). The first voltage Va1 is a voltage that makes the potential of the cathode electrode 14 higher than the potential of the anode electrode 18, and the second voltage Va2 is a voltage that makes the potential of the cathode electrode 14 lower than the potential of the anode electrode 18. The drive voltage Va has an amplitude Vin that can be defined by a value produced by subtracting the second voltage Va2 from the first voltage Va1(=Va1−Va2). Therefore, the waveform of the drive voltage Va in each period represents a rectangular pulse having the first voltage Va1 in the preparatory period T1 and the second voltage Va2 in the electron emission period T2.

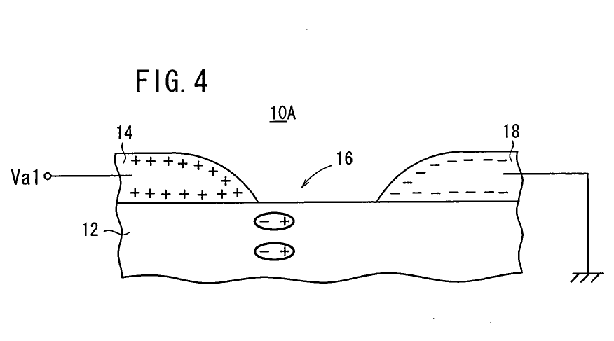

As shown in FIG. 4, the preparatory period T1 is a period in which the first voltage Va1 is applied between the cathode electrode 14 and the anode electrode 18 to polarize the emitter section 12. The first voltage Va1 may be a DC voltage, as shown in FIG. 3, but may be a single pulse voltage or a succession of pulse voltages. The preparatory period T1 should preferably be longer than the electron emission period T2 for sufficiently polarizing the emitter section 12. For example, the preparatory period T1 should preferably be 100 μsec. or longer. This is because the absolute value of the first voltage Va1 for polarizing the emitter section 12 is set to a smaller value than the absolute value of the second voltage Va2, for the purpose of reducing power consumption when the first voltage Va1 is applied, and preventing the cathode electrode 14 from being damaged.

The first voltage Va1 and the second voltage Va2 should preferably be of voltage levels for reliably polarizing the emitter section 12 into positive and negative poles. For example, if the dielectric material of the emitter section 12 has a coercive voltage, then the absolute values of the first voltage Va1 and the second voltage Va2 should preferably be higher than the coercive voltage.

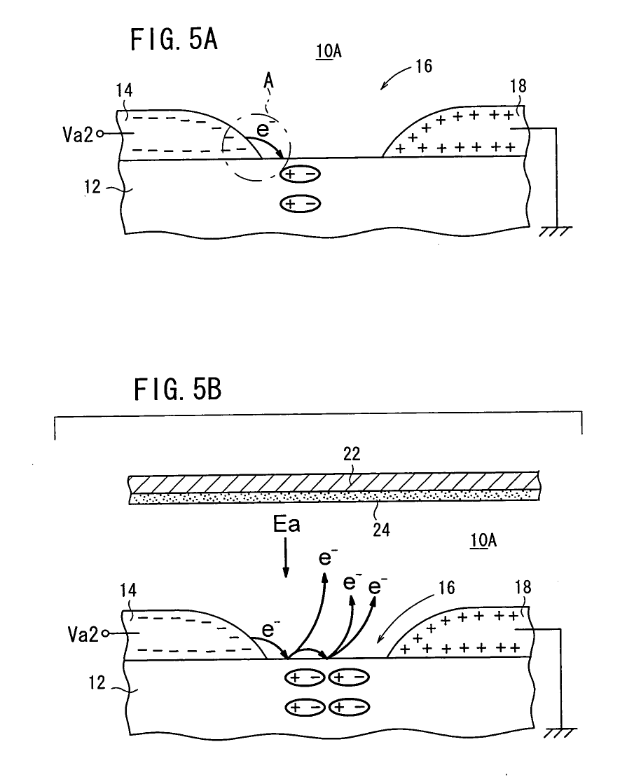

The electron emission period T2 is a period in which the second voltage Va2 is applied between the cathode electrode 14 and the anode electrode 18. When the second voltage Va2 is applied between the cathode electrode 14 and the anode electrode 18, the polarization of at least a portion of the emitter section 12 which is exposed through the slit 16 is reversed or changed, as shown in FIG. 5A. If the width of the slit 16 is represented by d (see FIG. 1) and the voltage applied between the cathode electrode 14 and the anode electrode 18 by Vak, then the polarization of the emitter section 12 is reversed or changed by an electric field E that is applied to the emitter section 12 and expressed by E=Vak/d.

Because of the reversed or changed polarization, a locally concentrated electric field is produced in the cathode electrode 14 and the positive poles of dipole moments in the vicinity of the cathode electrode 14, causing the cathode electrode 14 to emit primary electrons. As shown in FIG. 5B, the primary electrons emitted from the cathode electrode 14 impinge on the emitter section 12, causing the emitter section 12 to emit secondary electrons.

Specifically, the electron emitter 10A has the triple point A of the cathode electrode 14, the emitter section 12, and the vacuum. Primary electrons are emitted from the portion of the cathode electrode 14 in the vicinity of the triple point A, and the primary electrons emitted from the triple point A impinge on the emitter section 12, causing the emitter section 12 to emit secondary electrons. If the thickness of the cathode electrode 14 is extremely thin (up to 10 nm), then electrons are discharged from the interface between the cathode electrode 14 and the emitter section 12.

Because electrons are emitted by the above principles, the electron emitter 10 can stably emit electrons at a rate of two billion times or more, making the emission of electrons highly practical. Since the amount of emitted electrons increases in substantial proportion to the amplitude Vin of the drive voltage Va that is applied between the cathode electrode 14 and the anode electrode 18, it is easy to control the amount of emitted electrons.

Of the emitted secondary electrons, some are attracted to the collector electrode 22 and excite the phosphor 24 to produce fluorescent emission. The other secondary electrons and primary electrons are attracted to the anode electrode 18.

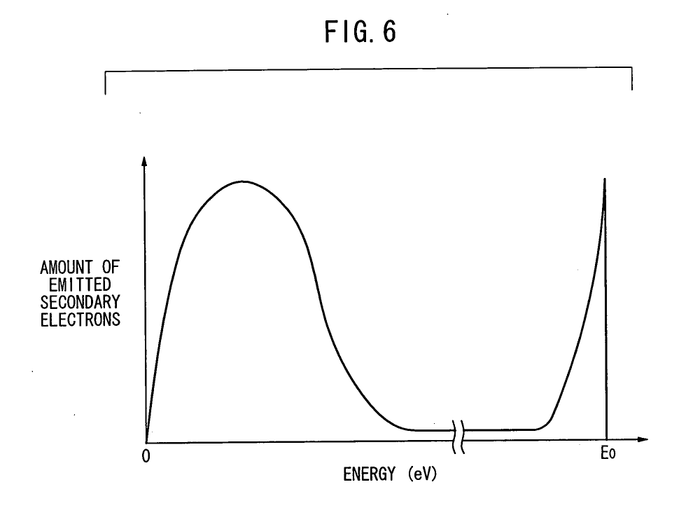

A distribution of emitted secondary electrons will be described below. As shown in FIG. 6, most of the emitted secondary electrons have energy level which is nearly zero. When the secondary electrons are emitted from the surface of the emitter section 12 into the vacuum, the secondary electrons only move according to an ambient electric field distribution. Specifically, the secondary electrons are accelerated from an initial speed of nearly 0 (m/sec) according to the ambient electric field distribution. Therefore, if an electric field Ea is produced between the emitter section 12 and the collector electrode 22, as shown in FIG. 5B, then the secondary electrons are emitted along a trajectory that is determined along the electric field Ea. The electron emitter 10A thus serves as an electron source for emitting electrons that move with high linearity. The secondary electrons that are emitted at the low initial speed are solid-state electrons that have jumped out of the emitter section 12 under the energy produced by coulomb collision with primary electrons.

By appropriately changing the pattern shape and potential of the collector electrode 22 and placing a control electrode (not shown) between the emitter section 12 and the collector electrode 22, the electric field distribution between the emitter section 12 and the collector electrode 22 may be modified as desired. Accordingly, the trajectory of emitted secondary electrons is easily controlled, and the diameter of the electron beam is easily converged, enlarged, and modified.

The electron source for emitting electrons that move with high linearity and the ease with which the trajectory of emitted secondary electrons can be controlled are advantageous for reducing the pitch of pixels of a display, which are constructed of the electron emitter 10A.

As can be seen from FIG. 6, some secondary electrons are emitted with an energy corresponding to the energy E₀ of the primary electrons. These secondary electrons are actually primary electrons that are emitted from the cathode electrode 14 and scattered near the surface of the emitter section 12 as reflected electrons.

If the thickness of the cathode electrode 14 is larger than 10 nm, then almost all of the reflected electrons are directed toward the anode electrode 18. The secondary electrons referred to in the present description are defined with the inclusion of reflected electrons and Auger electrons.

If the thickness of the cathode electrode 14 is extremely thin (up to 10 nm), then primary electrons emitted from the cathode electrons 14 are reflected by the interface between the cathode electrode 14 and the emitter section 12, and directed toward the collector electrode 22.

In the present embodiment, the collector electrode 22 is disposed on the reverse surface of the transparent plate 20, and the phosphor 24 is disposed on the surface of the collector electrode 22 which faces the cathode electrode 14. However, in an electron emitter 10Aa according to a first modification of the present invention, the phosphor 24 is disposed on the reverse surface of the transparent plate 20, and the collector electrode 22 is disposed on the transparent plate 20 so that it covers the phosphor 24.

The structure of the electron emitter 10Aa is used in a display such as a CRT where the collector electrode 22 functions as a metal back. Secondary electrons emitted from the emitter section 12 pass through the collector electrode 22 into the phosphor 24, exciting the phosphor 24. Therefore, the collector electrode 22 has such a thickness which allows the secondary electrons to pass therethrough, and the thickness should preferably be 100 nm or less. The greater the kinetic energy of the secondary electrons, the thicker the collector electrode 22.

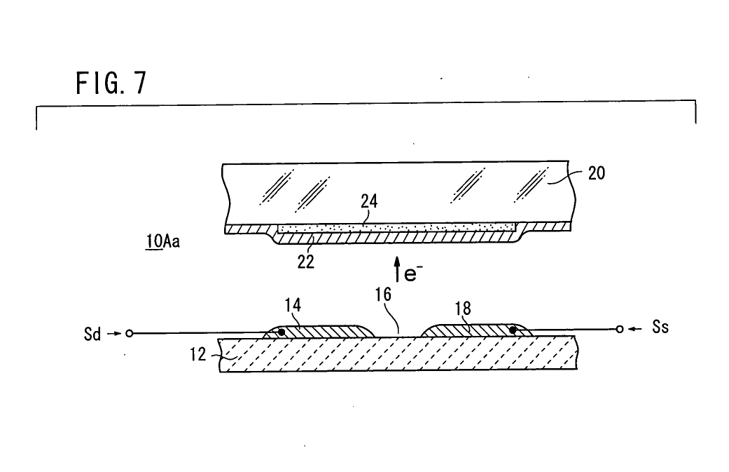

The electron emitter 10Aa shown in FIG. 7 offers the following advantages:

(1) If the phosphor 24 is not electrically conductive, then it is prevented from being negatively charged, and can maintain an electric field for accelerating secondary electrons.

(2) The collector electrode 22 reflects light emission from the phosphor 24 and hence directs the light efficiently toward the transparent plate 20 which serves as a light emission surface.

(3) The collector electrode 22 prevents excessive secondary electrons from colliding with the phosphor 24, which is thus prevented from being deteriorated and from producing a gas.

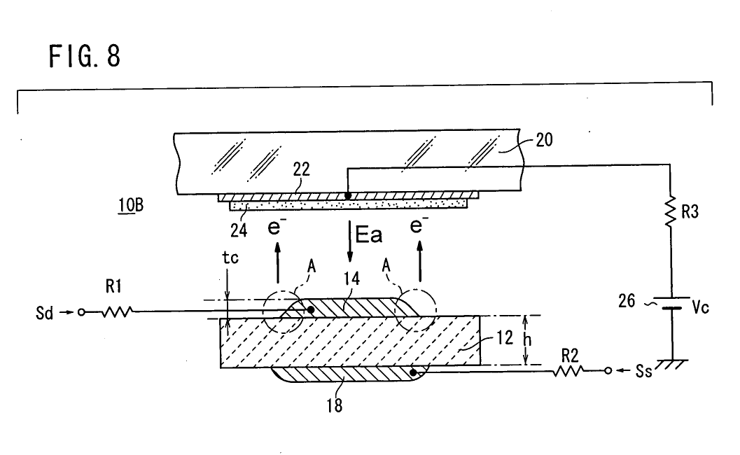

An electron emitter 10B according to a second embodiment of the present invention will be described below with reference to FIGS. 8 through 15B.

As shown in FIG. 8, the electron emitter 10B has a structure similar to the electron emitter 10A described above, but differs from the electron emitter 10A in that the cathode electrode 14 is disposed on the face surface of the emitter section 12, and the anode electrode 18 is disposed on the reverse surface of the emitter section 12.

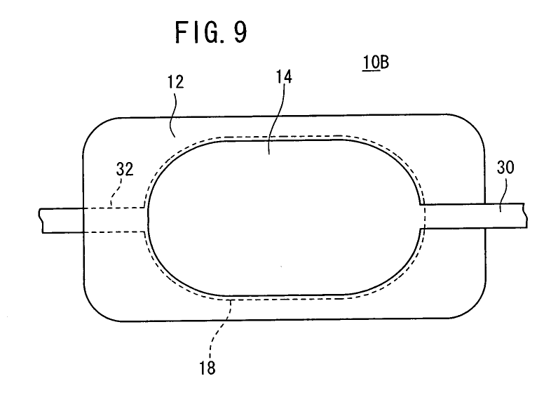

As shown in FIG. 9, for example, the drive voltage Va is applied between the cathode electrode 14 and the anode electrode 18 through a lead electrode 30 connected to the cathode electrode 14 and a lead electrode 32 connected to the anode electrode 18.

The thickness h of the emitter section 12 between the cathode electrode 14 and the anode electrode 18 will be described below. If the voltage between the cathode electrode 14 and the anode electrode 18 is represented by Vak, then the thickness h should preferably be set to reverse or change the polarization in an electric field E expressed by E=Vak/h. That is, if the thickness h is smaller, the polarization can be reversed or changed at a lower voltage, so that the electron emitter is capable of emitting electrons at a lower drive voltage (e.g., 100 V or less). The emitter section 12 should preferably have a dielectric breakdown voltage of at least 10 kV/mm. In the present embodiment, if the thickness h of the emitter section 12 is 20 μm, for example, then even when a drive voltage of −100 V is applied between the cathode electrode 14 and the anode electrode 18, the emitter section 12 will not suffer a dielectric breakdown.

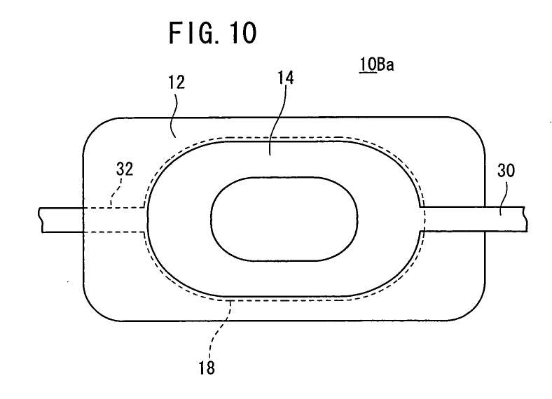

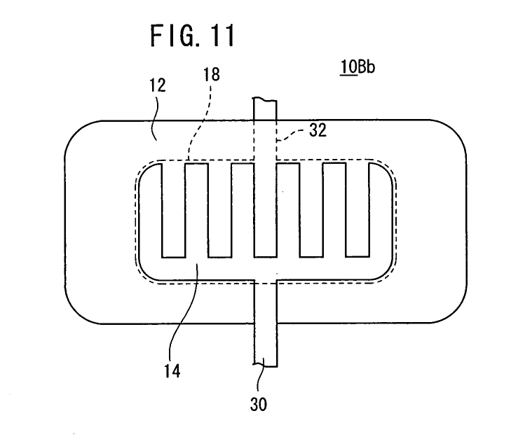

The plane surface of the cathode electrode 14 may have an elliptical shape, as shown in FIG. 9. Alternatively, the cathode electrode 14 may have a ring-shape as an electron emitter 10Ba shown in FIG. 10, or a comb-shape as an electron emitter 10Bb shown in FIG. 11.

The cathode electrode 14 with the ring- or comb-shape has a larger number of triple points, each made up of the cathode electrode 14, the emitter section 12, and the vacuum, as the electric field concentration point A, therefore increasing electron emission efficiency.

The cathode electrode 14 has a thickness tc (see FIG. 8) of 20 μm or less and preferably 5 μm or less. Therefore, the thickness tc of the cathode electrode 14 may be 100 nm or less. If the thickness tc of the cathode electrode 14 is extremely thin (10 nm or less), then electrons are emitted from the interface between the cathode electrode 14 and the emitter section 12, so that the electron emission efficiency can be further increased. The anode electrode 18 has a thickness of 20 μm or less and preferably 5 μm or less.

The principles by which electrons are emitted from the electron emitter 10B will be described below with reference to FIGS. 3, 8 and 12 through 15B. As shown in FIG. 3, as with the electron emitter 10A described above, the drive voltage Va applied between the cathode electrode 14 and the anode electrode 18 of the electron emitter 10B has a waveform in the form a step, which is repeated, including a period in which a first voltage Va1 is outputted (preparatory period T1) and a period in which a second voltage Va2 is outputted (electron emission period T2).

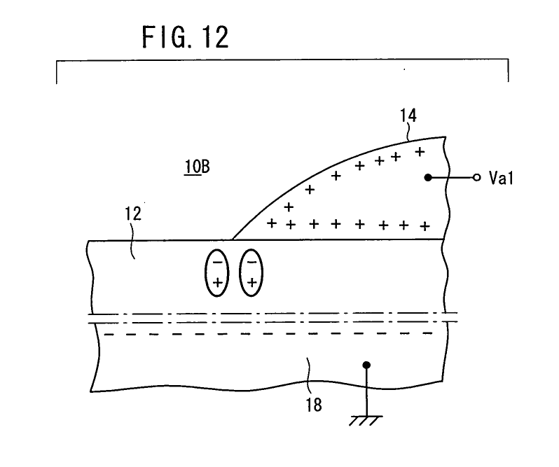

In the preparatory period T1, the first voltage Va1 is applied between the cathode electrode 14 and the anode electrode 18 to polarize the emitter section 12 in one direction, as shown in FIG. 12. The first voltage Va1 may be a DC voltage, as shown in FIG. 3, but may be a single pulse voltage or a succession of pulse voltages. The preparatory period T1 should preferably be longer than the electron emission period T2 for sufficiently polarizing the emitter section 12. For example, the preparatory period T1 should preferably be 100 μsec. or longer.

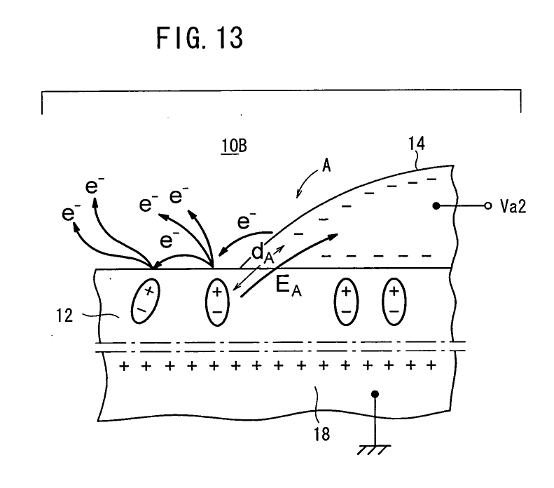

Thereafter, in the electron emission period T2, the second voltage Va2 is applied between the cathode electrode 14 and the anode electrode 18. At this time, the polarization of at least a portion of the emitter section 12 is reversed or changed, as shown in FIG. 13. The portion of the emitter section 12 of which polarization is reversed or changed includes not only a portion directly beneath the cathode electrode 14, but also an exposed portion of the surface without the cathode electrode 14 disposed thereon, in the vicinity of the cathode electrode 14, because the exposed portion of the emitter section 12 in the vicinity of the cathode electrode 14 is thought to be polarized. Because of the reversed or changed polarization, a locally concentrated electric field is produced in the cathode electrode 14 and the positive poles of dipole moments in the vicinity of the cathode electrode 14, causing the cathode electrode 14 to emit primary electrons. The primary electrons emitted from the cathode electrode 14 impinge on the emitter section 12, causing the emitter section 12 to emit secondary electrons.

Specifically, the electron emitter 10B has the triple point A that is made up of the cathode electrode 14, the emitter section 12, and the vacuum. Primary electrons are emitted from the portion of the cathode electrode 14 in the vicinity of the triple point A, and the primary electrons emitted from the triple point A impinge on the emitter section 12, causing the emitter section 12 to emit secondary electrons. If the thickness of the cathode electrode 14 is extremely thin (up to 10 nm), then electrons are discharged from the interface between the cathode electrode 14 and the emitter section 12.

An action that the electron emitter 10B performs when the second voltage Va2 is applied will be described in greater detail below. When the second voltage Va2 is applied between the cathode electrode 14 and the anode electrode 18, the emitter section 12 emits secondary electrons as described above. Specifically, in the emitter section 12 whose polarization is reversed or changed, dipole moments in the vicinity of the cathode electrode 14 draw emitted electrons.

Specifically, a local cathode is formed in the cathode electrode 14 in the vicinity of the interface between the cathode electrode 14 and the emitter section 12, and the positive poles of dipole moments that are charged in the vicinity of the cathode electrode 14 provide a local anode for drawing electrons from the cathode electrode 14. Of the drawn electrons, some are guided to the collector electrode 22 (see FIG. 8), exciting the phosphor 24 to produce fluorescent emission. Of the drawn electrons, others impinge on the emitter section 12, which emits secondary electrons which are guided to the collector electrode 22, exciting the phosphor 24 to produce fluorescent emission. The electron emitter 10B has a distribution of emitted secondary electrons similar to the distribution shown in FIG. 6. Therefore, most of the emitted secondary electrons have a energy level which is nearly zero. When the secondary electrons are emitted from the surface of the emitter section 12 into the vacuum, they only move according to an ambient electric field distribution. Specifically, the secondary electrons are accelerated from an initial speed of nearly 0 (m/sec) according to the ambient electric field distribution. Therefore, if there is an electric field Ea produced between the emitter section 12 and the collector electrode 22, as shown in FIG. 8, then the secondary electrons are emitted along a trajectory that is determined along the electric field Ea. The electron emitter 10B thus serves as an electron source for emitting electrons that move with high linearity. The secondary electrons that are emitted at the low initial speed are solid-state electrons that have jumped out of the emitter section 12 under the energy produced by coulomb collision with primary electrons.

Secondary electrons having an energy corresponding to the energy E₀ of the primary electrons are actually primary electrons that are emitted from the cathode electrode 14 and scattered near the surface of the emitter section 12 as reflected electrons. The secondary electrons that are emitted from the emitter section 12 toward the phosphor 24 include all of the secondary electrons having the low initial speed, i.e., solid-state electrons that have jumped out of the emitter section 12 under the energy produced by coulomb collision with primary electrons, Auger electrons, and reflected electrons. If the thickness of the cathode electrode 14 is extremely thin (up to 10 nm), then primary electrons emitted from the cathode electrons 14 are reflected by the interface between the cathode electrode 14 and the emitter section 12 and directed toward the collector electrode 22.

As shown in FIG. 13, the intensity E_{A} of the electric field at the electric field concentration point A is represented by E_{A}=V(1a, 1k)/d_{A} where V(1a, 1k) represents the potential difference between the local anode and the local cathode, and d_{A} represents the distance between the local anode and the local cathode. Inasmuch as the distance d_{A} between the local anode and the local cathode is very small, the intensity E_{A} of the electric field that is required to emit electrons can easily be achieved. In FIG. 13, the increased intensity E_{A} of the electric field is illustrated as the solid-line arrow. The increase in the intensity E_{A} of the electric field leads to a reduction in the voltage Vak.

As the emission of electrons from the cathode electrode 14 proceeds, constituent atoms of the emitter section 12 produced and floating when part of the emitter 14 is evaporated by the Joule heat, would be ionized into positive ions and electrons by the emitted electrons, and the produced electrons would further ionize constituent atoms of the emitter section 12. Since the electrons thus generated by the ionization would further ionize constituent atoms of the emitter section 12, electrons would be exponentially multiplied to generate a local plasma in which the electrons and the positive ions are neutral. The secondary electrons would promote the ionization. The generated positive ions would impinge on the cathode electrode 14, causing damage to the cathode electrode 14.

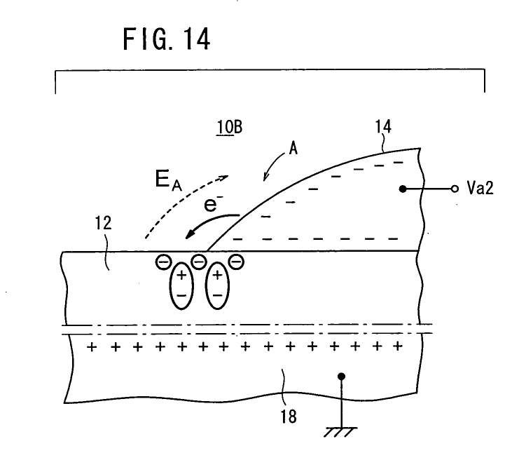

In the electron emitter 10B, however, as shown in FIG. 14, electrons drawn from the cathode electrode 14 are attracted to the positive poles of dipole moments in the emitter section 12 as the local anode, negatively charging the surface of the emitter section 12 in the vicinity of the cathode electrode 14. As a result, a factor for accelerating electrons (a local potential difference) is reduced, and a potential for emitting secondary electrons is eliminated, allowing the surface of the emitter section 12 to be further negatively charged.

Therefore, the positiveness of the local anode provided by the dipole moments is weakened, and the intensity E_{A} of the electric field between the local anode and the local cathode is reduced. In FIG. 14, the reduced intensity E_{A} of the electric field is illustrated as the broken-line arrow. The reduction in the intensity EA of the electric field stops the emission of electrons.

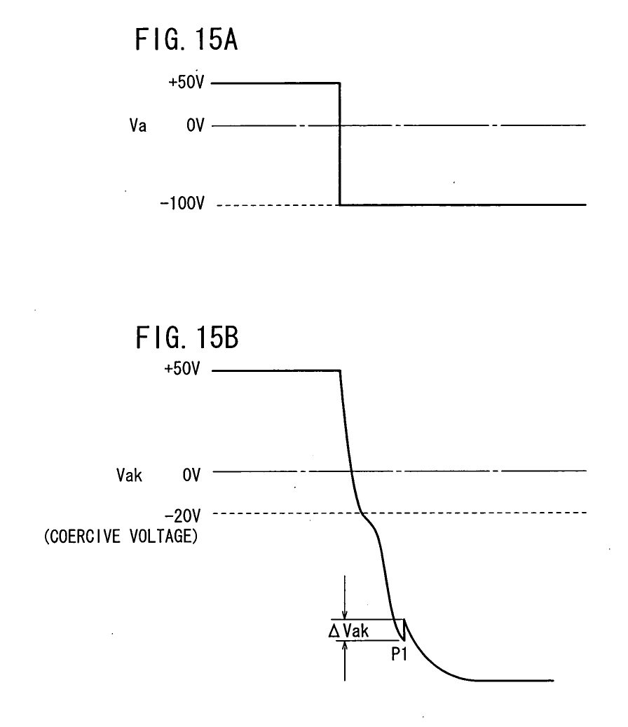

Specifically, as shown in FIG. 15A, the drive voltage Va applied between the cathode electrode 14 and the anode electrode 18 includes, for example, a first voltage Va1 of +50 V and a second voltage Va2 of −100 V. A voltage change ΔVak that occurs between the cathode electrode 14 and the anode electrode 18 at a peak time P1 when electrons are emitted is in the range of 20 V (about 10 V in FIG. 15B), and hence the voltage between the cathode electrode 14 and the anode electrode 18 undergoes almost no change. Therefore, almost no positive ions are produced, and the cathode electrode 14 is prevented from being damaged by positive ions. Accordingly, the electron emitter 10B can have an extended service life.

When electrons emitted from the emitter section 12 again impinge on the emitter section 12, or when ionization occurs in the vicinity of the surface of the emitter section 12, the emitter section 12 may be damaged or crystalline defects may be induced, making the structure of the emitter section 12 weak.

It is therefore preferable to construct the emitter section 12 of a dielectric material having a high evaporation temperature in vacuum, e.g., BaTiO₃ or the like which does not contain Pb. The emitter section 12 thus constructed has its constituent atoms less liable to evaporate due to the Joule heat, obstructing the promotion of ionization by electrons. This is effective in protecting the surface of the emitter section 12.

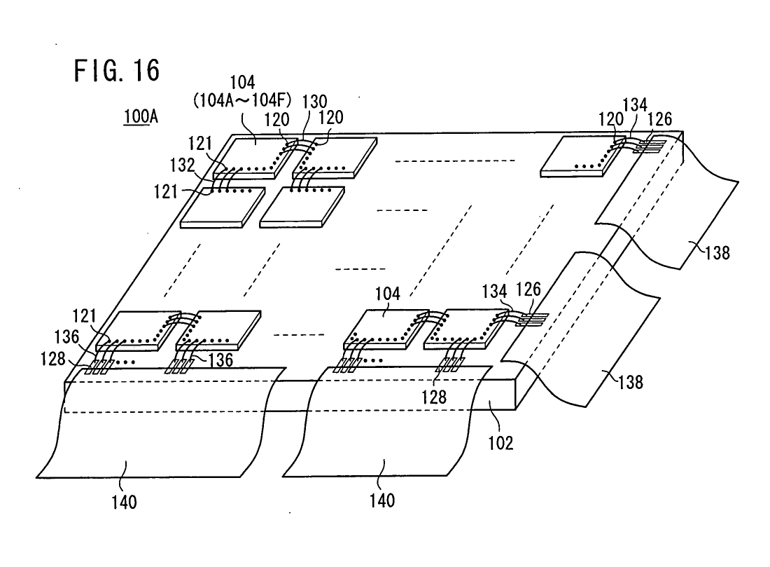

A display 100A according to a first-embodiment of the present invention will be described below with reference to FIGS. 16 through 32.

As shown in FIG. 16, the display 100A generally comprises a mother board 102 having a size large enough to display images, and an array of modules 104 disposed on the mother board 102. The modules 104 may be arranged in a matrix on the mother board 102. The mother board 102 may comprise a glass substrate.

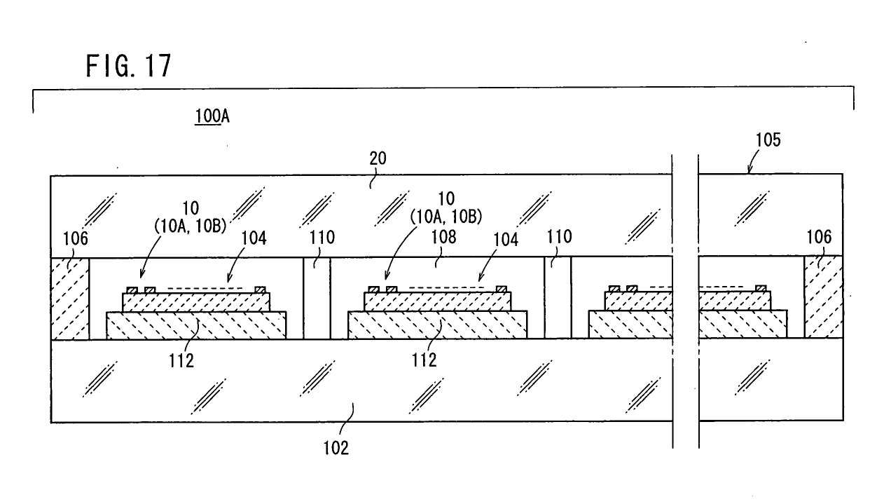

As shown in FIG. 17, the display 100A has a transparent plate 20 facing the mother board 102. An outer frame 106 of ceramics is interposed between the outer peripheral edges of the mother board 102 and the transparent plate 20, and sealed in place, making a housing 105. A space 108 defined between the mother board 102 and the transparent plate 20 and surrounded by the outer frame 106 is evacuated to develop a vacuum. In other words, the inside of the housing 105 is a vacuum. One or more spacers 110 may be interposed at desired positions between the mother board 102 and the transparent plate 20 to keep a gap at a predetermined distance between the mother board 102 and the transparent plate 20.

The collector electrode 22 and the phosphor 24 (see FIG. 1), although not shown in FIG. 17, are disposed on the reverse surface of the transparent plate 20 which faces the mother board 102.

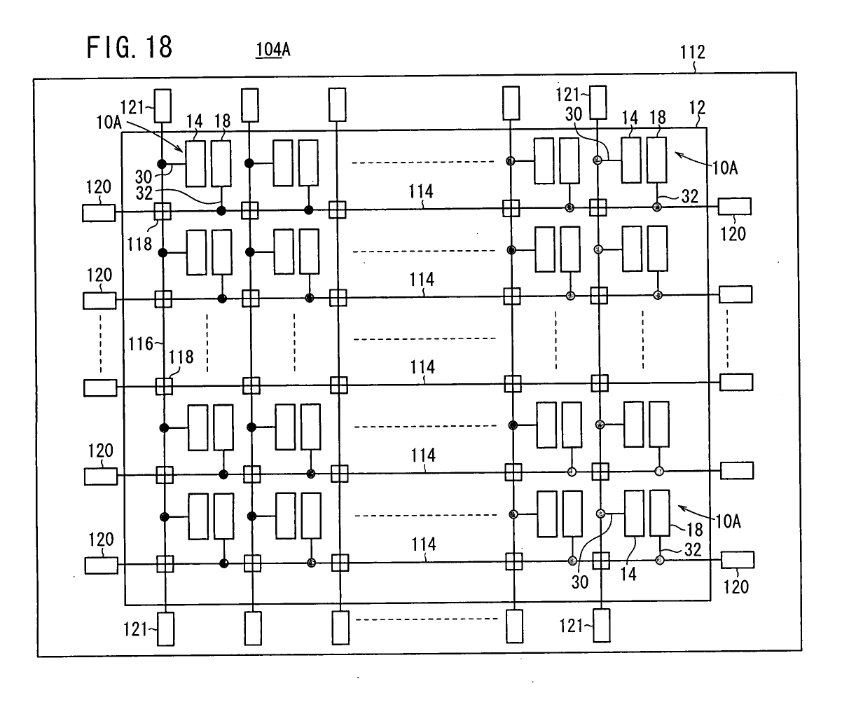

Specific examples of modules 104 will be described below with reference to FIGS. 18 through 32. As shown in FIG. 18, a module 104A according to a first specific example comprises a single module board 112, a single emitter section 12 disposed on the module board 112, and a number of electron emitters 10A disposed as a matrix on the upper surface of the emitter section 12. That is, the electron emitters 10A, each having the cathode electrode 14, the anode electrode 18, and the slit 16, are disposed as a matrix on the upper surface of the single emitter section 12. The module board 112 comprises a ceramic substrate such as of alumina, zirconia, or a glass substrate.

The emitter section 12 also supports thereon, in addition the cathode electrodes 14 and the anode electrodes 18, a number of row selection lines 114 extending horizontally along respective rows and a number of signal lines 116 extending vertically along respective columns.

Specifically, a single signal line 116 is placed between every two horizontally adjacent electron emitters 10A, and a single row selection line 114 is placed between every two vertically adjacent electron emitters 10A. Each anode electrode 18 is connected to a row selection line 114 by a lead electrode 32, and each cathode electrode 14 is connected to a signal line 116 by a lead electrode 30. An insulating layer 118 for electrically insulating the row selection line 114 and the signal line 116 is interposed between the row selection line 114 and the signal line 116 where they cross.

Pads 120 as many as the number of row selection lines 114 on one module 104A are disposed on the horizontal ends (left and right ends in FIG. 18) of the upper peripheral surface of the module board 112, and pads 121 as many as the number of signal lines 116 on one module 104A are disposed on the vertical ends (upper and lower ends in FIG. 18) of the upper peripheral surface of the module board 112.

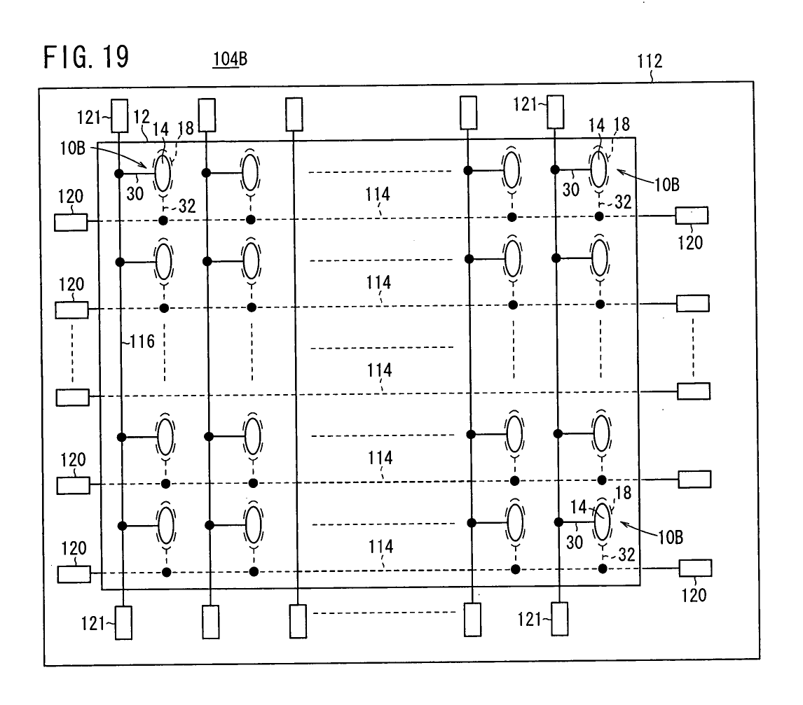

As shown in FIG. 19, a module 104B according to a second specific example is similar to the above module 104A according to the first specific example, but differs in that a number of electron emitters 10B are disposed as a matrix on the module board 112.

Specifically, a number of anode electrodes 18 are disposed as a matrix on the upper surface of the single module board 112, and a single emitter section 12 covers the anode electrodes 18. A number of cathode electrodes 14 are disposed on the upper surface of the emitter section 12 in respective regions aligned with the respective anode electrodes 18 beneath the emitter section 12.

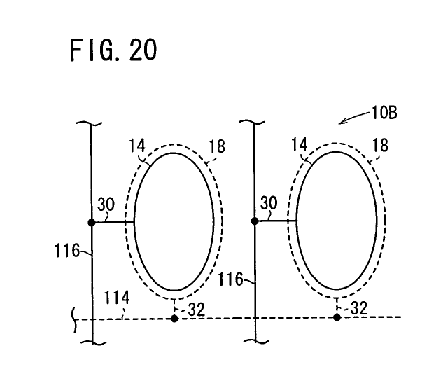

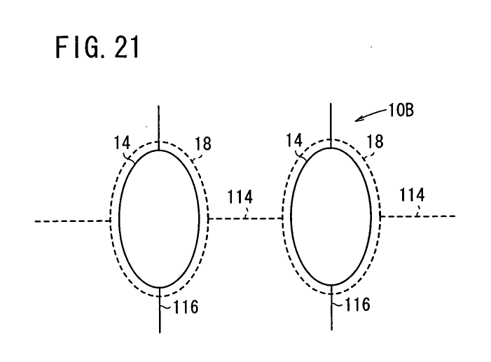

A number of row selection lines 114 extending horizontally along respective rows are disposed, in addition to the anode electrodes 18, on the upper surface of the module board 112 beneath the emitter section 12. As shown in FIG. 20, the row selection lines 114 may be spaced from the anode electrodes 18 and connected thereto by respective lead electrodes 32. Alternatively, as shown in FIG. 21, the row selection lines 114 may be disposed so as to pass through the centers of the anode electrodes 18.

A number of signal lines 116 extending vertically along respective columns are disposed, in addition to the cathode electrodes 14, on the upper surface of the emitter section 12. As shown in FIG. 20, the signal lines 116 may be spaced from the cathode electrodes 14 and connected thereto by respective lead electrodes 30. Alternatively, as shown in FIG. 21, the signal lines 116 may be disposed so as to pass through the centers of the cathode electrodes 14.

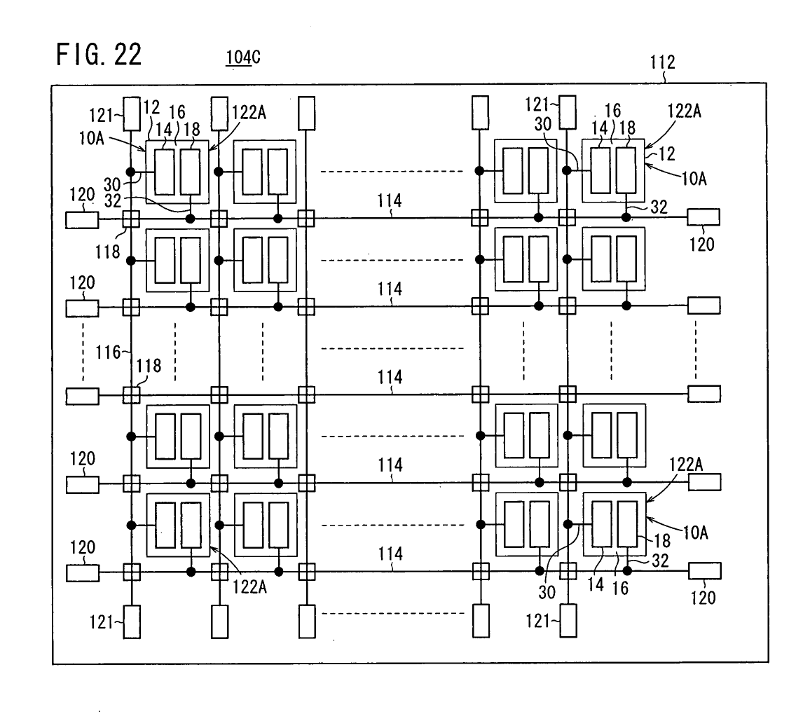

As shown in FIG. 22, a module 104C according to a third specific example is similar to the above module 104A according to the first specific example, but differs in that the emitter section 12 is divided into as many segments as the number of electron emitters 10A, and both row selection lines 114 and signal lines 116 are disposed on the upper surface of the module board 112. Specifically, the module 104A has as many blocks 122A as the number of electron emitters 10A, disposed as a matrix on the module board 112. Each of the blocks 122A has a single emitter section 12, a cathode electrode 14 disposed on the upper surface of the emitter section 12, and an anode electrode 18 disposed on the upper surface of the emitter section 12, and a slit 16 is defined between the cathode electrode 14 and the anode electrode 18.

A single signal line 116 is placed between every two horizontally adjacent blocks 122A, and a single row selection line 114 is placed between every two vertically adjacent blocks 122A. Each anode electrode 18 is connected to a row selection line 114 by a lead electrode 32, and each cathode electrode 14 is connected to a signal line 116 by a lead electrode 30. An insulating layer 118 for electrically insulating the row selection line 114 and the signal line 116 is interposed between the row selection line 114 and the signal line 116 where they cross.

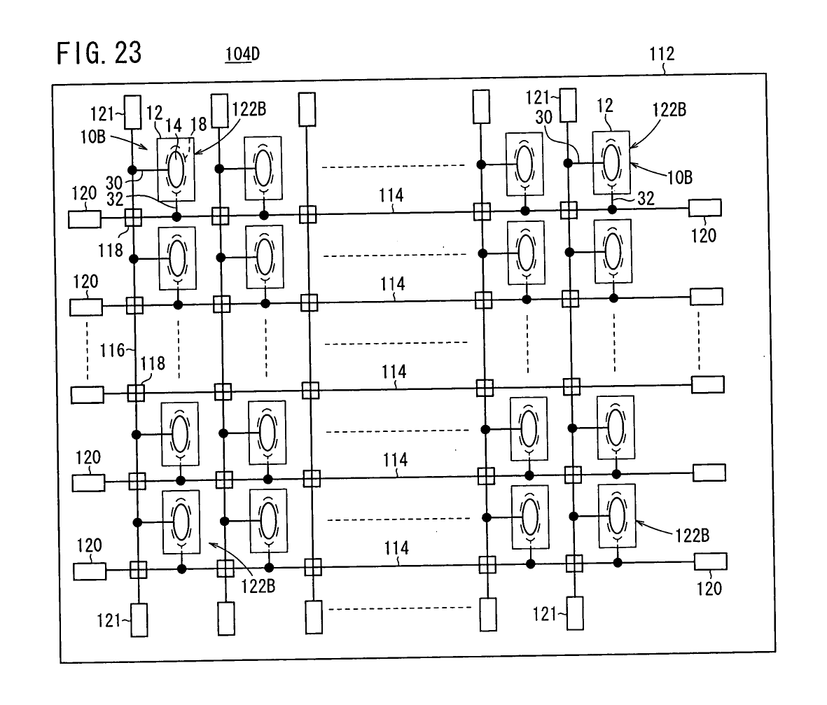

As shown in FIG. 23, a module 104D according to a fourth specific example is similar to the above module 104B according to the second specific example, but differs in that the emitter section 12 is divided into as many segments as the number of electron emitters 10B, and both row selection lines 114 and signal lines 116 are disposed on the upper surface of the module board 112. Specifically, the module 104D has as many blocks 122B as the number of electron emitters 10B, disposed as a matrix on the module board 112. Each of the blocks 122B has a single emitter section 12, an anode electrode 18 disposed beneath the emitter section 12, and a cathode electrode 14 disposed on the upper surface of the emitter section 12. Each anode electrode 18 is connected to a row selection line 114 by a lead electrode 32, and each cathode electrode 14 is connected to a signal line 116 by a lead electrode 30.

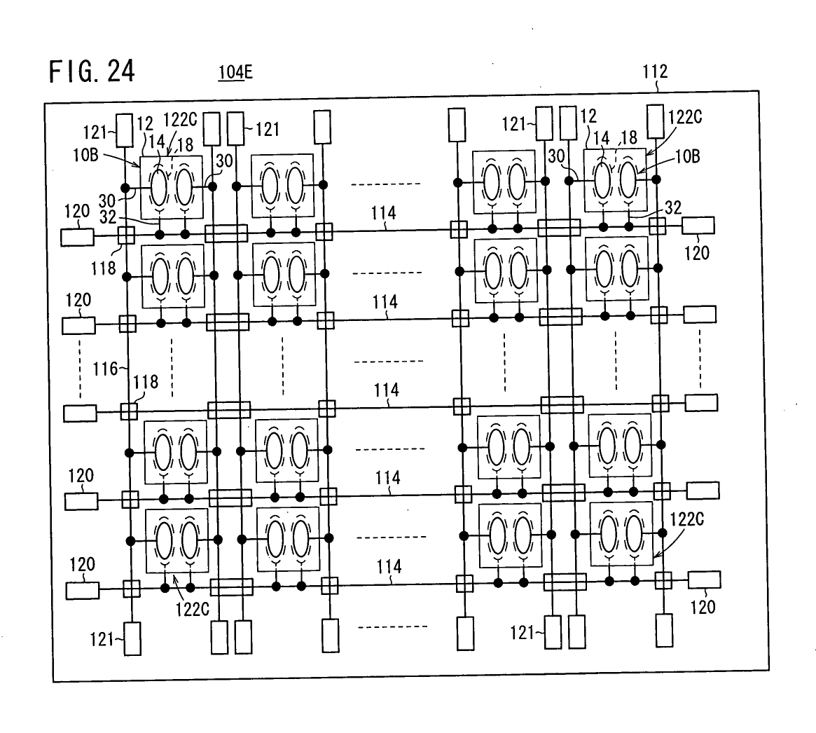

As shown in FIG. 24, a module 104E according to a fifth specific example is similar to the above module 104D according to the fourth specific example, but differs in that two electron emitters 10B are assigned to a single block 122C and are arrayed horizontally. Specifically, each block 122C has a single emitter section 12, two anode electrodes 18 disposed beneath the emitter section 12, and two cathode electrodes 14 disposed on the upper surface of the emitter section 12.

Two signal lines 116 are placed between every two horizontally adjacent blocks 122C, and a single row selection line 114 is placed between every two vertically adjacent blocks 122C.

The block 122C on the mth row and the nth column has a left electron emitter 10B corresponding to a dot on the (2n-1)th column, and a right electron emitter 10B corresponding to a dot on the 2nth column. There are two signal lines 116 between the block 122C on the mth row and the nth column and a block 122C adjacent to that block 122C, e.g., the block 122C on the mth row and (n-1)th column, and the left signal line 116 of the two signal lines 116 corresponds to the block 122C on the mth row and (n-1)th column, and the right signal line 116 corresponds to the block 122C on the mth row and nth column.

On the block 122C on the mth row and nth column, two anode electrodes 18 are connected to the row selection line 114 by respective lead electrodes 32, the cathode electrode 14 on the mth row and (2n-1)th column is connected to the left signal line 116 (the signal line on the mth row and (2n-1)th column) by the lead electrode 30, and the cathode electrode 14 on the mth row and 2nth column is connected to the right signal line 116 (the signal line on the mth row and 2nth column) by the lead electrode 30. An insulating layer 118 for electrically insulating each row selection line 114 and each signal line 116 is interposed between the row selection line 114 and the signal line 116 where they cross.

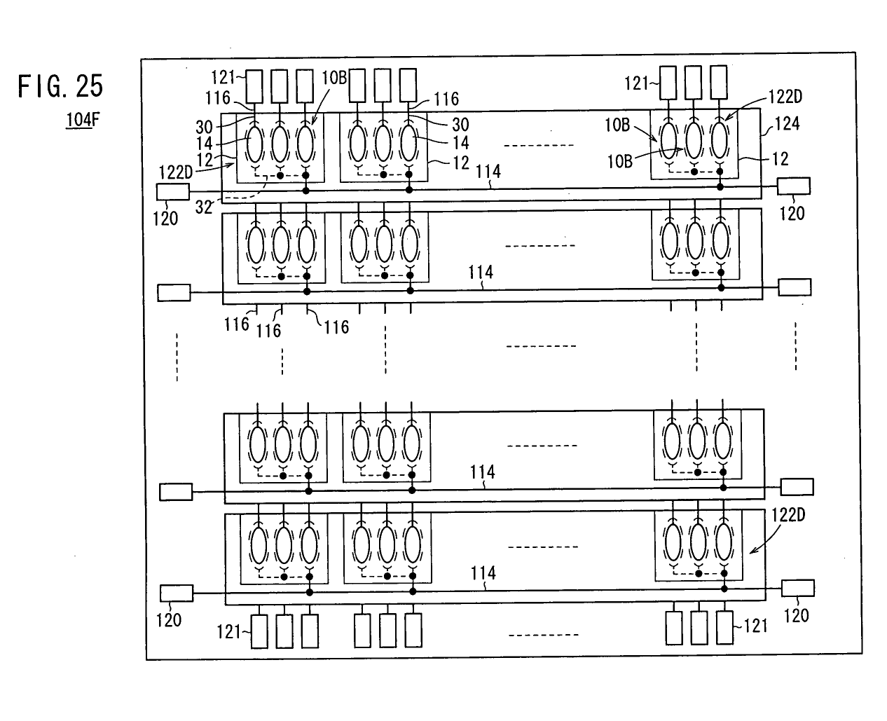

As shown in FIG. 25, a module 104F according to a sixth specific example is similar to the above module 104D according to the fourth specific example, but differs in that three electron emitters 10B corresponding to, for example, red, green, and blue, respectively, are assigned to a single block 122D and are arrayed horizontally.

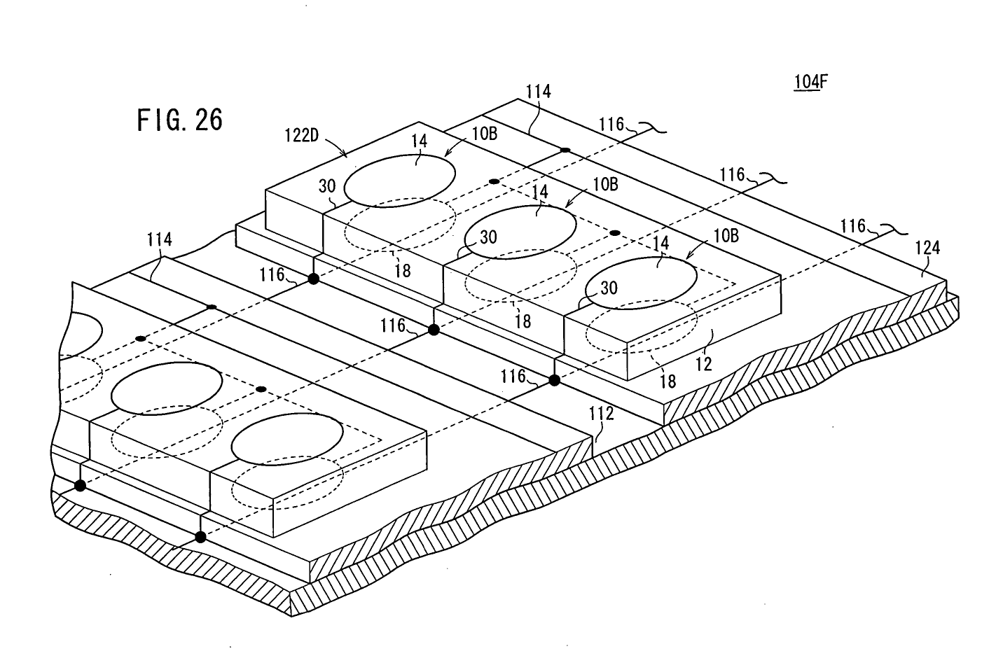

An insulating layer 124 (dielectric layer) for insulating the row selection lines 114 and the signal lines 116 are disposed on the upper surface of the module board 112, as described later on. As shown in FIG. 26, each block 122D has three anode electrodes 18 disposed on the upper surface of the insulating layer 124, an emitter section 12 covering the three anode electrodes 18, and three cathode electrodes 14 disposed on the upper surface of the emitter section 12.

A number of signal lines 116 extending vertically along respective rows are disposed on the upper surface of the module board 112 beneath the insulating layer 124. As shown in FIG. 25, three signal lines 116 are disposed respectively at the centers of three cathode electrodes 14 on each of the blocks 122D.

A single row selection line 114 is laid out on the upper surface of the insulating layer 124 between every two vertically adjacent blocks 122D. On each of the blocks 122D, the three anode electrodes 18 are connected to the row selection line 114 by a common lead electrode 32. The three anode electrodes 18 are connected to the corresponding signal lines by individual lead electrodes 30.

As shown in FIG. 16, a number of modules 104A-104F are arrayed on the mother board 102, constructing the display 100A. Pads 126 as many as the number of all row selection lines 114 of the display 100A are disposed on a horizontal end (a right end in FIG. 16) of the upper peripheral surface of the mother board 102, and pads 128 as many as the number of all signal lines 116 of the display 100A are disposed on a vertical end (a lower end in FIG. 16) of the upper peripheral surface of the mother board 102.

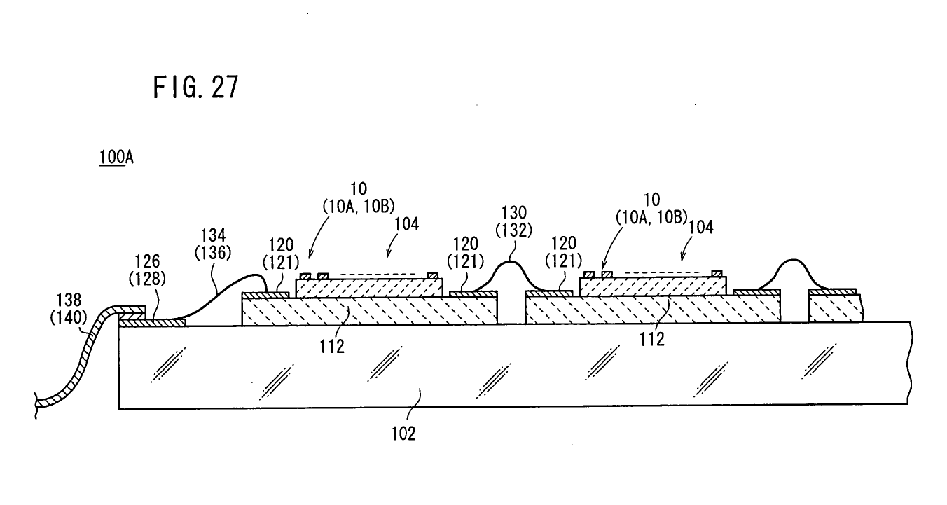

As shown in FIG. 27, the adjacent pads 120 on modules 104 are connected by, for example, bonding wires 130, and the adjacent pads 121 on modules 104 are connected by, for example, bonding wires 132. Pads 120 on modules 104 that are positioned on a horizontal end of the mother board 102 and pads 126 on the mother board 102 are connected by bonding wires 134, and pads 121 on modules 104 that are positioned on a vertical end of the mother board 102 and pads 128 on the mother board 102 are connected by bonding wires 136. The pads 126, 128 on the mother board 102 may be made of ACF (Anisotropic Conductive Film). Cables 138 in the form of FPCs (Flexible Printed Circuits), TAB (Tape Automated Bonding) assemblies, or the like for direct row selection lines are connected to the pads 126, and cables 140 in the form of FPCs, TAB assemblies, or the like for direct signal lines are connected to the pads 128.

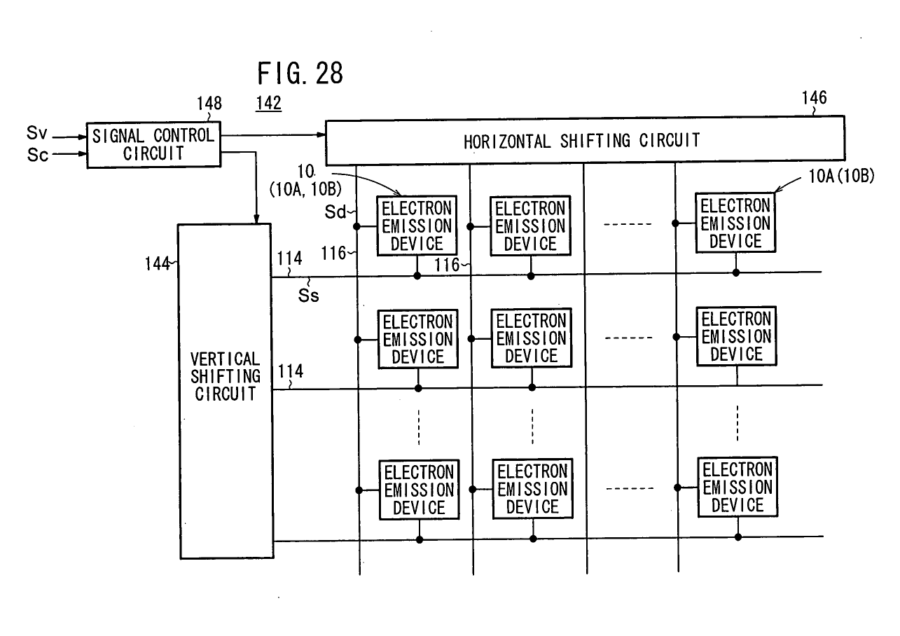

As shown in FIG. 28, the display 100A has a peripheral circuit 142 including a vertical shifting circuit 144 for selectively supplying selection signals Ss to the row selection lines 114 to successively select rows of electron emitters 10A (10B), a horizontal shifting circuit 146 for selectively supplying pixel signals Sd to the rows selected by the vertical shifting circuit 144, and a signal control circuit 148 for controlling the vertical shifting circuit 144 and the horizontal shifting circuit 146 based on a video signal Sv and a synchronizing signal Sc that are supplied to the signal control circuit 148.

Operation of the display 100A will be described below. In the description which follows, the electron emitters 10A, 10B will collectively be referred to as electron emitters 10.

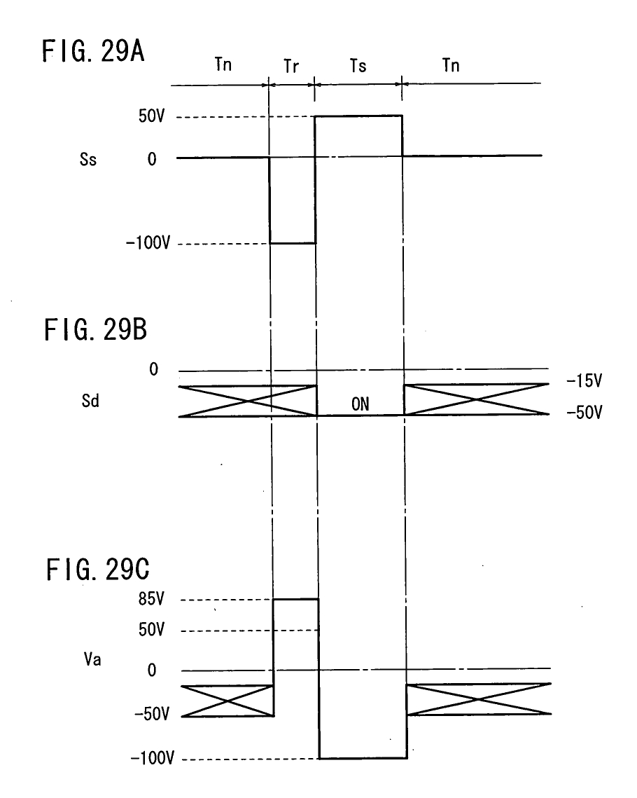

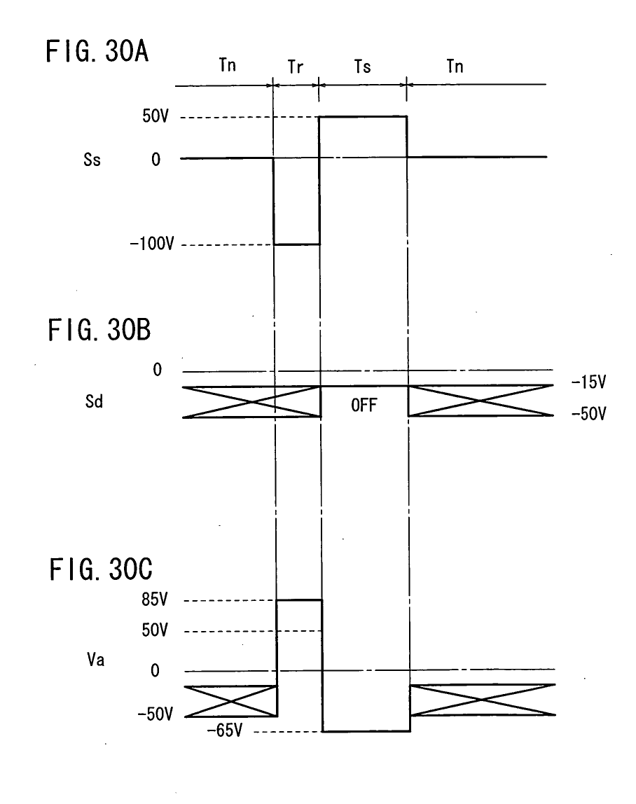

When none of the electron emitters 10 are selected, a voltage of 0 V, for example, is applied to the anode electrodes 18 of all the electron emitters 10 through the row selection lines 114. As shown in FIGS. 29A and 30A, a voltage of 0 V is applied to the anode electrodes 18 of those electron emitters 10 which are in an unselected period Tn through the row selection lines 114.

Thereafter, for selecting the electron emitters 10 of the first row, for example, a voltage of −100 V is applied through the row selection line 114 of the first row to the anode electrodes 18 of the respective electron emitters 10 of the first row in a resetting period Tr immediately before a selecting period Ts for the first row. Since, in the resetting period Tr for the first row, a voltage of −50 V or −15 V, for example, for turning on or off electron emitters is being applied to the cathode electrodes 14 of the respective electron emitters 10 of the final row through the signal line 116, a voltage of −50 V or −15 V, for example, is also applied to the cathode electrodes 14 of the respective electron emitters 10 of the first row through the signal line 116.

Therefore, a voltage of 50 V or 85 V is applied between the cathode and anode electrodes 14, 18 of the respective electron emitters 10 of the first row, polarizing the emitters 12 of the respective electron emitters 10 of the first row in one direction.

For subsequently selecting the electron emitters 10 of the first row, i.e., in the selection period Ts, a voltage of 50 V is applied through the row selection line 114 of the first row to the anode electrodes 18 of the respective electron emitters 10 of the first row. As shown in FIG. 29B, a voltage of −50 V is applied to the cathode electrodes 14 of those electron emitters 10 which are to be turned on through the corresponding signal lines 116, of all the electron emitters 10 of the first row, and, as shown in FIG. 30B, a voltage of −15 V is applied to the cathode electrodes 14 of those electron emitters 10 which are to be turned off through the corresponding signal lines 116, of all the electron emitters 10 of the first row.

As a result, as shown in FIG. 29C, a voltage of −100 V, for example, that is sufficient to emit electrons is applied in the selection period Ts for the first row between the cathode and anode electrodes 14, 18 of those electron emitters 10 which are to be turned on, of all the electron emitters 10 of the first row. Therefore, those electron emitters 10 are turned on, emitting electrons to cause fluorescent emission.

As shown in FIG. 30C, a voltage of −65 V, for example, that is not sufficient to emit electrons is applied in the selection period Ts for the first row between the cathode and anode electrodes 14, 18 of those electron emitters 10 which are to be turned off, of all the electron emitters 10 of the first row. Therefore, those electron emitters 10 are turned off, i.e., optically quenched, and do not emit electrons.

A voltage of −15 V or −50 V is applied to the cathode electrodes 14 of the electron emitters 10 of the rows which are not selected, through the signal lines 116. As shown in FIGS. 29A and 30A, a voltage of 0 V is applied to the anode electrodes 18 of the electron emitters 10 of the rows which are not selected, through the row selection lines 114. Inasmuch as a voltage of −50 V or more which is not sufficient to emit electrons is applied to the electron emitters 10 of the unselected rows, no electrons are emitted from the electron emitters 10 of the unselected rows.

The first, second, third, . . . , nth rows of electron emitters 10 are successively selected in synchronization with a horizontal synchronizing signal, and the scanning spot is returned to the first row in synchronization with a vertical synchronizing signal, for thereby enabling the display 100A to display a still image or a moving image on its screen, i.e., the surface of the transparent plate 20.

As described above, the display 100A has a plurality of modules 104, each having a matrix of electron emitters 10, disposed on the mother board 102 and electrically interconnected, and the modules 104 are sealed in vacuum in the housing 105. The display 100A can thus easily provide a large display screen.

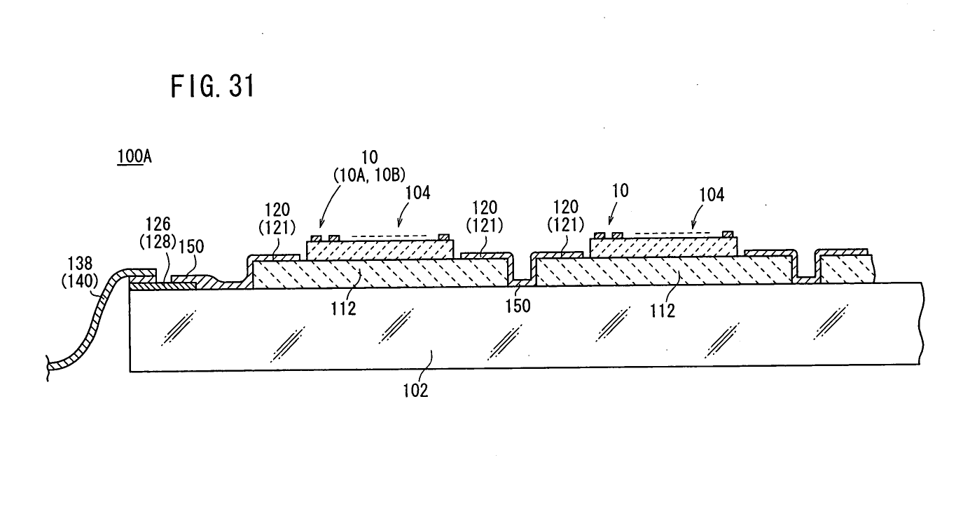

In the structure shown in FIG. 27, the adjacent modules 104 are electrically interconnected and the modules 104 on the ends of the mother board 102 are electrically connected to the pads 126, 128 on the mother board 102 by bonding wires. However, as shown in FIG. 31, such electrical connections may be made by electric conductors or interconnection patterns 150 produced by a screen printing process, an ink jet process, a thin-film forming process, or the like. Since the electric conductors or interconnection patterns 150 thus produced allow a large number of electrical connections to be formed altogether, displays 100A can be manufactured with an increased throughput at a low cost.

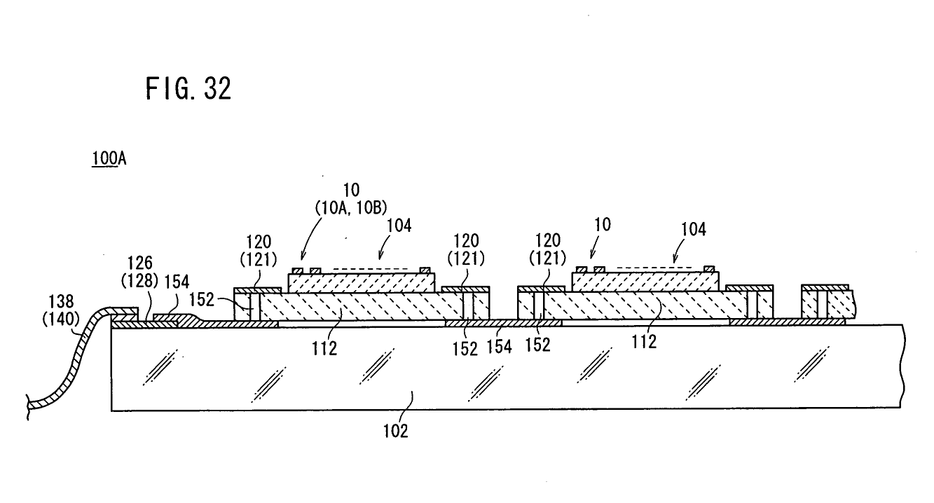

FIG. 32 shows still another pattern of interconnections of the display 100A. In FIG. 32, each module 104 has through holes 152 defined in the module board 112 beneath the pads 120, 121, and electric conductors or interconnection patterns 154 are formed on the upper surface of the mother board 102 by a screen printing process, an ink jet process, a thin-film forming process, or the like so as to be electrically connected through the through holes 152 to the pads 120, 121. In this manner, the adjacent modules 104 are electrically interconnected and the modules 104 on the ends of the mother board 102 are electrically connected to the pads 126, 128 by those electric conductors or interconnection patterns 154. Since the electric conductors or interconnection patterns 154 thus produced allow a large number of electrical connections to be formed altogether, displays 100A can be manufactured with an increased throughput at a low cost.

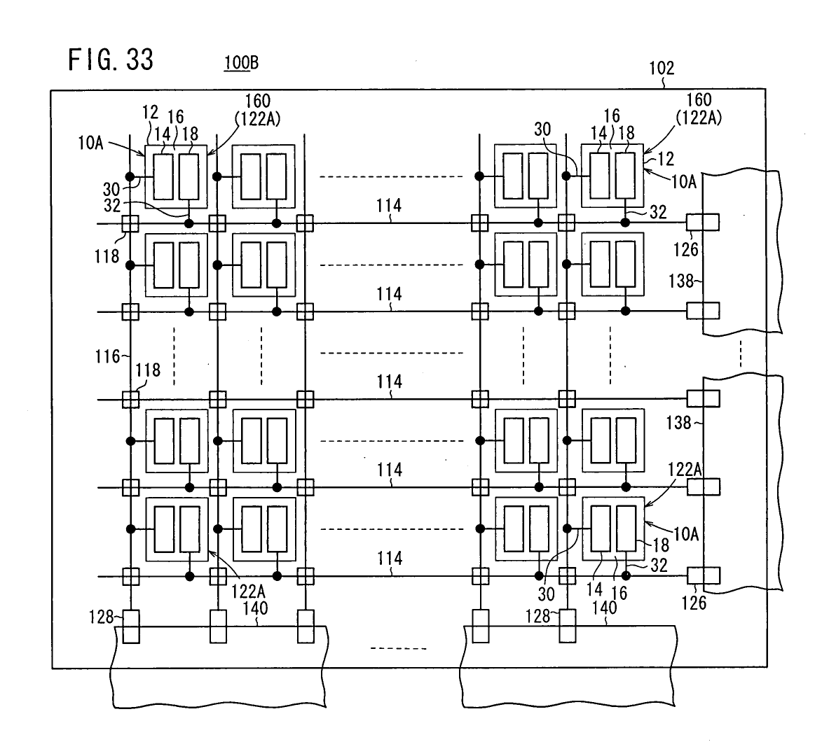

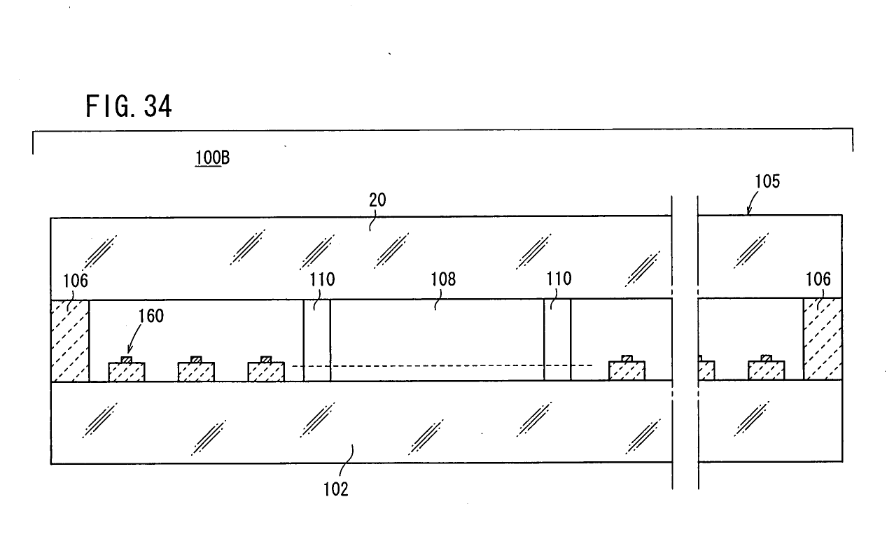

A display 100B according to a second embodiment of the present invention will be described below with reference to FIGS. 33 and 34.

As shown in FIG. 33, the display 100B generally comprises a mother board 102 and an array of chips 160 disposed on the mother board 102. The chips 160 are fixed to the mother board 102, for example, by adhesive.

Each of the chips 160 may comprise one of the blocks 122A of the module 104A shown in FIG. 22, for example, which is packaged as a chip. Though not shown, either one of the blocks 122B through 122D of the modules 104D through 104F shown in FIGS. 23 through 25 may be packaged as a chip and used as each of the chips 160.

As shown in FIG. 34, the display 100B has a transparent plate 20 facing the mother board 102. An outer frame 106 is interposed between the outer peripheral edges of the mother board 102 and the transparent plate 20, and sealed in place, making up a single housing 105. A space 108 defined between the mother board 102 and the transparent plate 20 and surrounded by the outer frame 106 is evacuated to develop a vacuum. In other words, the inside of the housing 105 is a vacuum. One or more spacers 110 may be interposed at desired positions between the mother board 102 and the transparent plate 20 to keep a gap at a predetermined distance between the mother board 102 and the transparent plate 20.

The chips 160, i.e., chips with respective electron emitters 10 mounted thereon, are arrayed as a matrix on the mother board 102, and electrically interconnected, and the chips 160 are sealed in vacuum in the housing 105. Therefore, the display 100B can easily provide a large display screen.

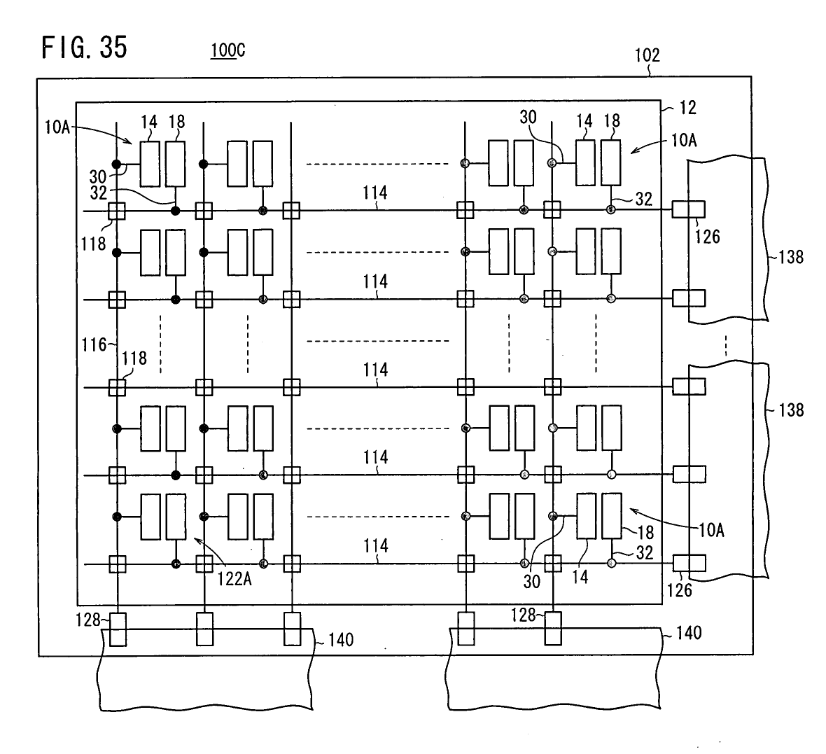

A display 100C according to a third embodiment of the present invention will be described below with reference to FIGS. 35 through 42.

As shown in FIG. 35, the display 100C has a single emitter section 12 disposed on and extending substantially fully over the upper surface of a mother board 102, and a number of electron emitters 10A disposed as a matrix on the upper surface of the emitter section 12. That is, the electron emitters 10A, each having the cathode electrode 14, the anode electrode 18, and the slit 16, are disposed as a matrix on the upper surface of the single emitter section 12. Other structural details of the display 100C are identical to those of a larger-size version of the module 10A shown in FIG. 18, and will not be described in detail below.

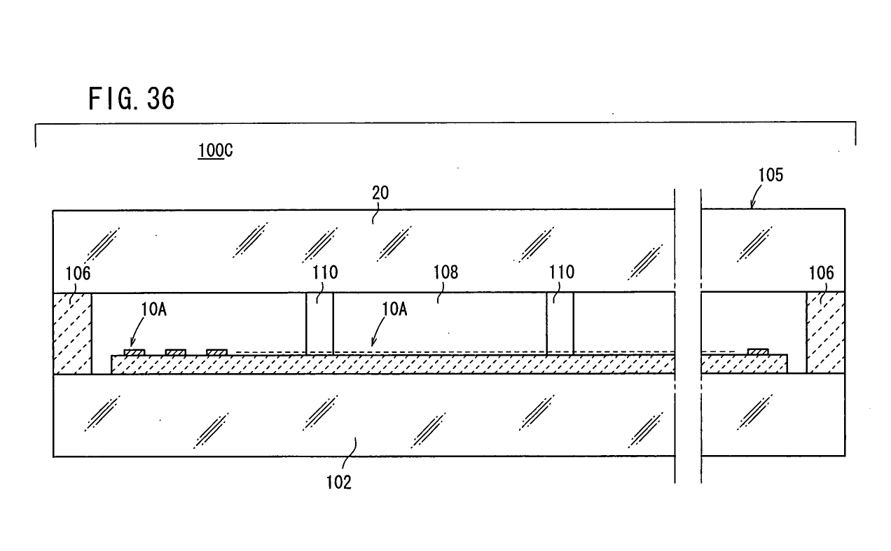

As shown in FIG. 36, the display 100C has a transparent plate 20 facing the mother board 102. An outer frame 106 is interposed between the outer peripheral edges of the mother board 102 and the transparent plate 20, and sealed in place, making up a single housing 105. A space 108 defined between the mother board 102 and the transparent plate 20 and surrounded by the outer frame 106 is evacuated to develop a vacuum. In other words, the inside of the housing 105 is a vacuum. One or more spacers 110 may be interposed at desired positions between the mother board 102 and the transparent plate 20 to keep a gap at a predetermined distance between the mother board 102 and the transparent plate 20.

In the display 100C, the electron emitters 10A and interconnection patterns (row selection lines 114 and signal lines 116) are formed as films directly on the mother board 102. The electron emitters 10A and a large number of electrical connections can thus be formed together. Displays 100C can be manufactured with an increased throughput at a low cost.

If a paste is used in forming films as the emitters 12, etc., then the entire assembly needs to be baked after the paste is formed. Since the mother board 102 which comprises a glass substrate has a low melting point, the paste should preferably be of the low-temperature baking type.

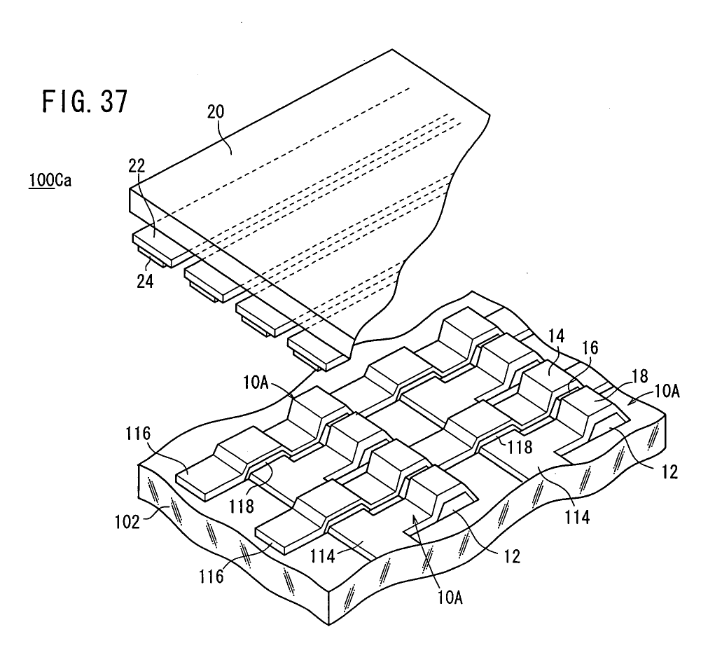

Some modifications of the display 100C will be described below with reference to FIGS. 37 through 42.

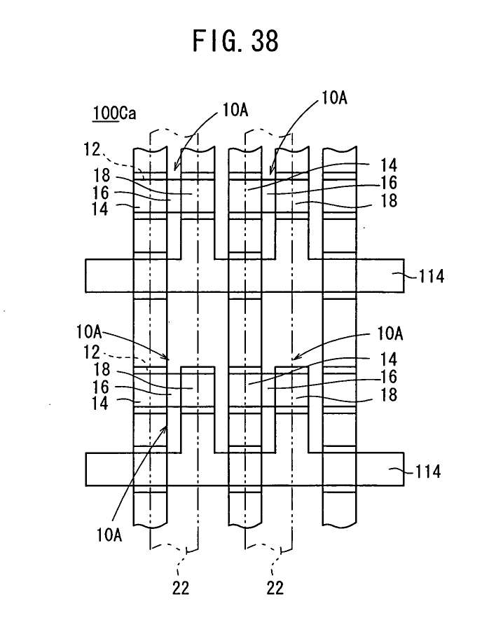

As shown in FIGS. 37 and 38, a display 100Ca according to a first modification has, disposed on a mother board 102, a number of row selection lines 114 extending horizontally along respective rows and a number of signal lines 116 extending vertically along respective columns. Insulating layers 118 for electrically insulating the row selection lines 114 and the signal lines 116 are interposed between the row selection lines 114 and the signal lines 116 where they cross.

Cathode electrodes 14 which extend vertically are integrally formed with the row selection lines 114 at respective positions thereof. The signal lines 116 have portions which face the respective cathode electrodes 14 in the horizontal direction. Those portions of the signal lines 116 which face the respective cathode electrodes 14 will be referred to as anode electrodes 18.

Each of the electron emitters 10A of the display 100Ca comprises a cathode electrode 14, an anode electrode 18, and an emitter section 12 disposed beneath the cathode electrode 14 and the anode electrode 18.

Each of the electron emitters 10A also has a slit 16 defined between the cathode electrode 14 and the anode electrode 18. The emitter section 12 disposed beneath the cathode electrode 14 and the anode electrode 18 has an upper surface exposed through the slit 16.

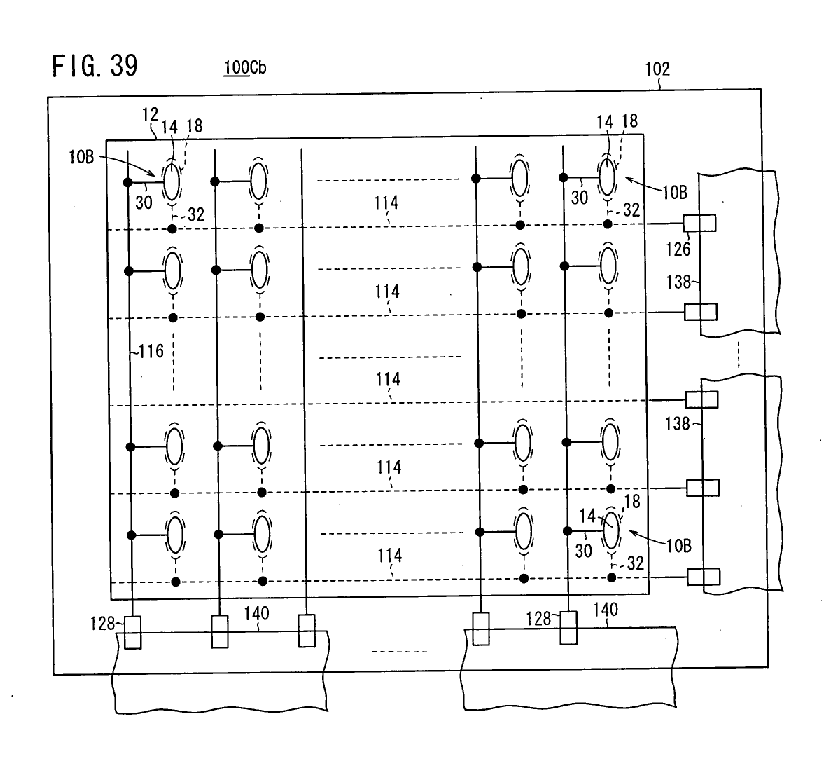

A display 100Cb according to a second modification is shown in FIG. 39. As shown in FIG. 39, the display 100Cb has a structure similar to the display 100C described above, but differs in that a number of electron emitters 10B are disposed as a matrix on the mother board 102.

Specifically, a number of anode electrodes 18 are disposed as a matrix on the upper surface of the mother board 102, and a single emitter section 12 covers the anode electrodes 18. A number of cathode electrodes 14 are disposed on the upper surface of the emitter section 12 in respective regions aligned with the respective anode electrodes 18 beneath the emitter section 12.

A number of row selection lines 114 extending horizontally along respective rows are disposed, in addition to the anode electrodes 18, on the upper surface of the mother board 102 beneath the emitter section 12. A number of signal lines 116 extending vertically along respective columns are disposed, in addition to the cathode electrodes 14, on the upper surface of the emitter section 12. The row selection lines 114 and the signal lines 116 may be of the interconnection pattern shown in FIG. 20 or 21.

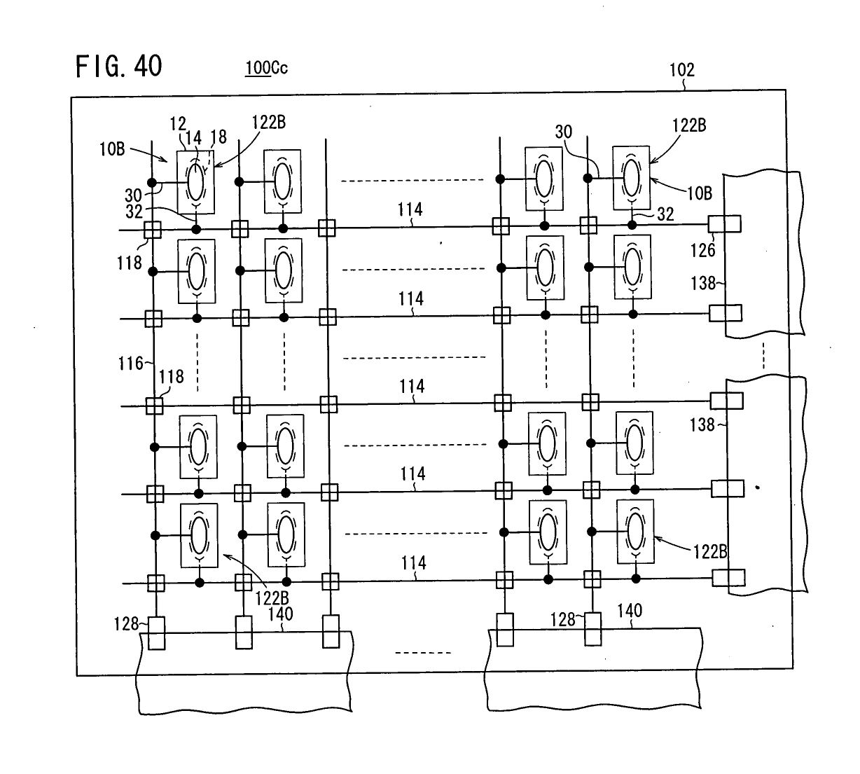

A display 100Cc according to a third modification is shown in FIG. 40. As shown in FIG. 40, the display 100Cc has a structure similar to the display 100Cb described above, but differs in that an electron emitters 10B are disposed as a matrix, the emitter section 12 is divided into as many segments as the number of electron emitters 10B, and both row selection lines 114 and signal lines 116 are disposed on the upper surface of the mother board 102.

Specifically, as many blocks 122B of the module 104D shown in FIG. 23 as the number of electron emitters 10B are disposed as a matrix on the mother board 102. Each anode electrode 18 is connected to a row selection line 114 by a lead electrode 32, and each cathode electrode 14 is connected to a signal line 116 by a lead electrode 30.

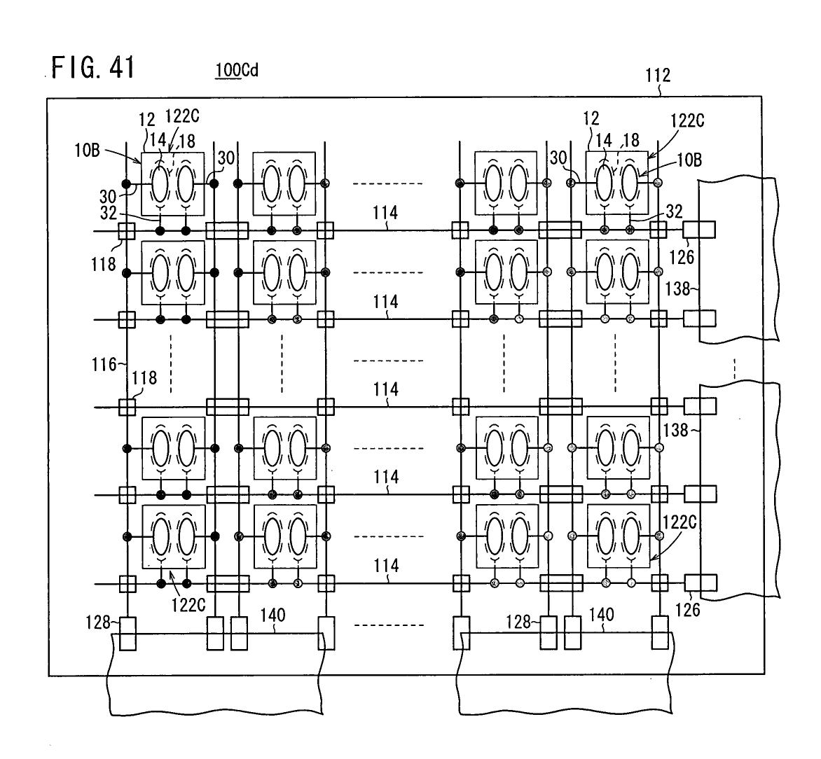

As shown in FIG. 41, a display 100Cd according to a fourth modification has a number of blocks 122C of the module 104E shown in FIG. 24, disposed as a matrix on the mother board 102.

Two signal lines 116 are placed between every two horizontally adjacent blocks 122C, and a single row selection line 114 is placed between every two vertically adjacent blocks 122C.

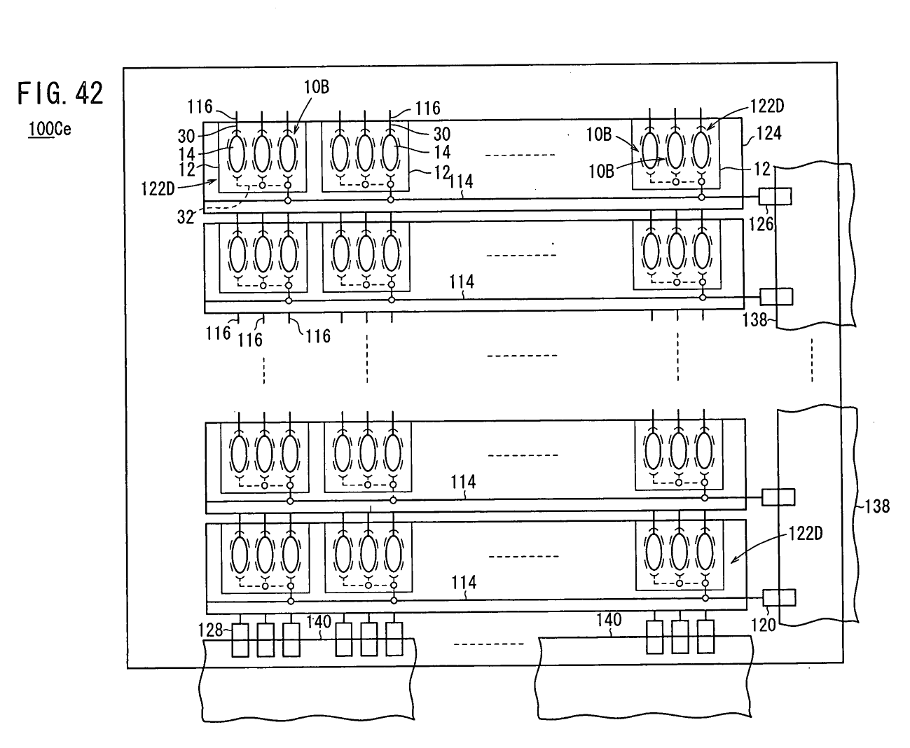

As shown in FIG. 42, a display 100Ce according to a fifth modification has a number of blocks 122D of the module 104F shown in FIG. 25, disposed as a matrix on the mother board 102.

A number of signal lines 116 extending vertically along respective rows are disposed on the upper surface of the mother board 102 beneath the insulating layer 124. Three signal lines 116 are disposed respectively at the centers of three cathode electrodes 14 on each of the blocks 122D.

A single row selection line 114 is placed on the upper surface of the insulating layer 124 between every two vertically adjacent blocks 122D. On each of the blocks 122D, the three anode electrodes 18 are connected to the row selection line 114 by a common lead electrode 32. The three cathode electrodes 14 are connected to the corresponding signal lines 116 by individual lead electrodes 30.

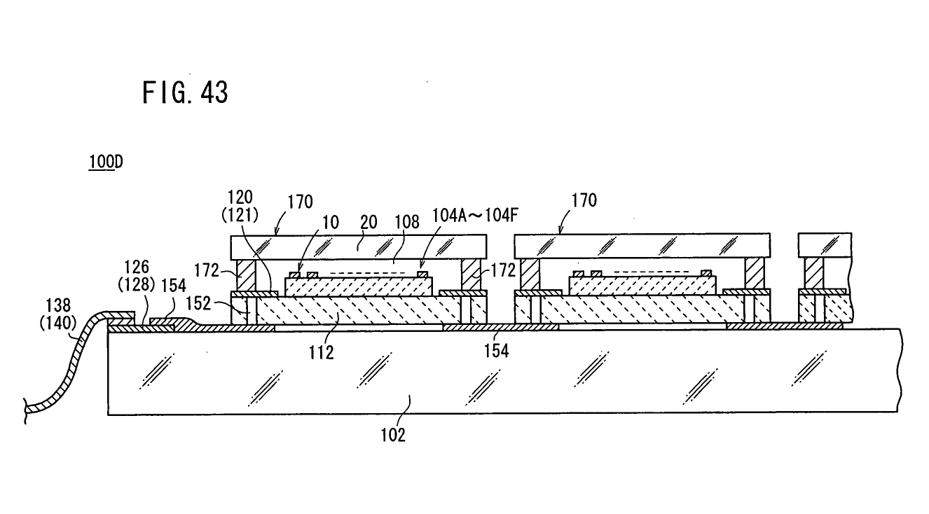

A display 100D according to a fourth embodiment of the present invention will be described below with reference to FIG. 43.

As shown in FIG. 43, the display 100D has a mother board 102 having a size large enough to display images, and an array of vacuum-sealed modules 170 disposed on the mother board 102. Each of the modules 170 may comprise either one of the modules 104A through 104F shown in FIGS. 18 through 26. Specifically, as shown in FIG. 43, in each module which may be one of the modules 104A through 104F, a transparent plate 20 faces the module board 112. An outer frame 172 is interposed between the outer peripheral edges of the module board 112 and the transparent plate 20, and sealed in place therebetween. A space 108 defined between the module board 112 and the transparent plate 20 and surrounded by the outer frame 172 is evacuated to develop a vacuum therein, thus providing a vacuum-sealed module 170.

In each of the vacuum-sealed modules 170, through holes 152 are defined in the module board 112 beneath the pads 120, 121, and electric conductors or interconnection patterns 154 are formed on the upper surface of the mother board 102 by a screen printing process, an ink jet process, a thin-film forming process, or the like so as to be electrically connected through the through holes 152 to the pads 120, 121. In this manner, the adjacent vacuum-sealed modules 170 are electrically interconnected, and the vacuum-sealed modules 170 on the ends of the mother board 102 are electrically connected to the pads 126, 128 by those electric conductors or interconnection patterns 154.

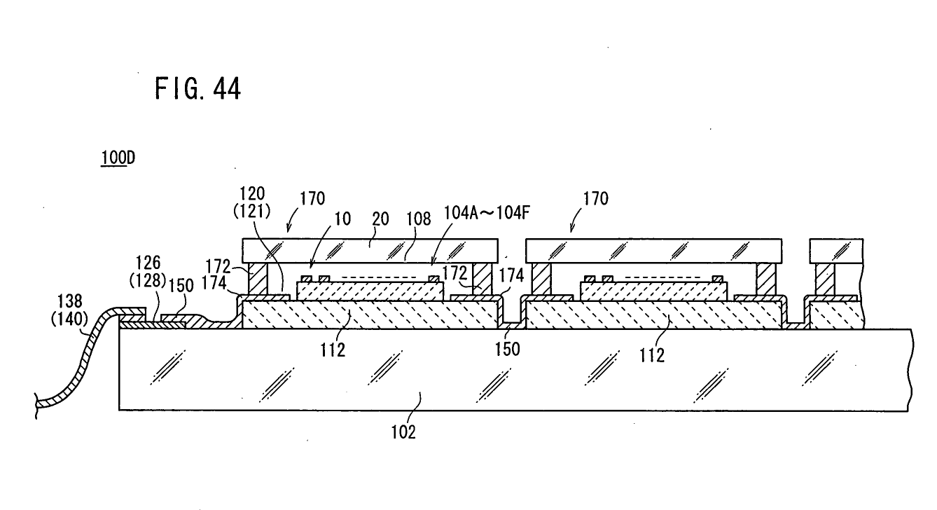

Alternatively, as shown in FIG. 44, end electrodes 174 which extend from the pads 120, 121 of the vacuum-sealed modules 170 are formed in advance, and are connected to each other directly, or by electric conductors or interconnection patterns 150, thereby electrically interconnecting the adjacent vacuum-sealed modules 170. The end electrodes 174 of those vacuum-sealed modules 170 which are disposed on ends of the mother board 102 may be electrically connected to the pads 126, 128 by those electric conductors or interconnection patterns 150.

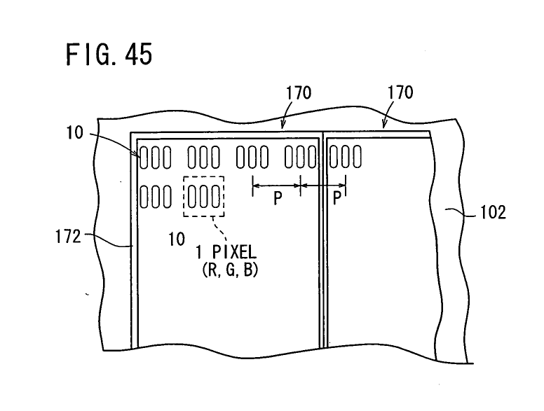

If the vacuum-sealed modules 170 are evacuated to a low vacuum of several hundreds Pa, then the sealed structure may be simplified, and the space required to seal the vacuum-sealed modules 170 may be saved. Therefore, when the vacuum-sealed modules 170 are arrayed, as shown in FIG. 45, pixel pitches P may be substantially equalized between the adjacent vacuum-sealed modules 170, resulting in less distinctive junctions between the adjacent vacuum-sealed modules 170.

Preferred materials of the components of the displays 100A through 100D will be described below.

The emitter section 12 is made of a dielectric material. The dielectric material should preferably have a relatively high specific dielectric constant, e.g., a relative dielectric constant of 1000 or higher. Dielectric materials of such may be ceramics including barium titanate, lead zirconate, lead magnesium niobate, lead nickel niobate, lead zinc niobate, lead manganese niobate, lead magnesium tantalate, lead nickel tantalate, lead antimony stannate, lead titanate, lead magnesium tungstate, lead cobalt niobate, etc., ceramics containing a desired combination of these compounds, materials whose chief constituent contains 50 weight % or more of these compounds, or materials containing the above ceramics and oxides of lanthanum, calcium, strontium, molybdenum, tungsten, barium, niobium, zinc, nickel, manganese, etc., any combinations thereof, or other compounds added thereto.

For example, a two-component n-PMN-mPT compound (n, m represent molar ratios) of lead magnesium niobate (PMN) and lead titanate (PT) has its Curie point lowered and its relative dielectric constant increased at room temperature when the molar ratio of PMN is increased.

Particularly, if n=0.85 to 1.0, m=1.0−n, then the relative dielectric constant has a preferable value of 3000 or higher. For example, if n=0.91, m=0.09, then the relative dielectric constant of 15000 at room temperature is achieved, and if n=0.95, m=0.05, the relative dielectric constant of 20000 at room temperature is achieved.

A three-component compound of lead magnesium niobate (PMN), lead titanate (PT), and lead zirconate (PZ) may have its relative dielectric constant increased by making the compound have a composition in the vicinity of a morphotropic phase boundary (MPB) between a tetragonal system and a pseudo-cubic system or a tetragonal system and a rhombohedral system. For example, the relative dielectric constant of 5500 is achieved preferably with PMN:PT:PZ=0.375:0.375:0.25, and the relative dielectric constant of 4500 is achieved preferably with PMN:PT:PZ=0.5 0.375:0.125. It is also preferable to increase the dielectric constant by mixing the above dielectric materials with a metal such as platinum insofar as electric insulation is maintained. For example, the dielectric materials are mixed with 20 weight % of platinum.

The emitter section 12 may be in the form of a piezoelectric/electrostrictive layer or an anti-ferroelectric layer. If the emitter section 12 comprises a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstate, lead cobalt niobate, or the like, or a combination of any of these materials.

The emitter section 12 may be made of chief components including 50 weight % or more of any of the above compounds. Of the above ceramics, the ceramics including lead zirconate is most frequently used as a constituent of the piezoelectric/electrostrictive layer of the emitter section 12.

If the piezoelectric/electrostrictive layer is made of ceramics, then oxides of lanthanum, calcium, strontium, molybdenum, tungsten, barium, niobium, zinc, nickel, manganese, or the like, or a combination of these materials, or other compounds may be added to the ceramics.

For example, the piezoelectric/electrostrictive layer should preferably be made of ceramics including chief components of lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the emitter section 12 is in the form of an anti-ferroelectric layer, then the anti-ferroelectric layer may be made of lead zirconate or a component of lead zirconate and lead stannate as a chief component, lead zirconate with lanthanum oxide added thereto, or lead zirconate and lead stannate as components with lead zirconate and lead niobate added thereto.

The anti-ferroelectric layer may also be porous. If the anti-ferroelectric layer is porous, then it should preferably have a porosity of 30% or less.

If the emitter section 12 is made of strontium tantalate bismuthate, then its polarization inversion fatigue is small and preferable. Materials whose polarization inversion fatigue is small are laminar ferroelectric compounds and expressed by the general formula of (BiO₂)²⁺(Aₘ₋₁BₘO₃ₘ₊₁)²⁻. Ions of the metal A are Ca²⁺, Sr²⁺, Ba²⁺, Pb²⁺, Bi³⁺, La³⁺, etc., and ions of the metal B are Ti⁴⁺, Ta⁵⁺, Nb⁵⁺, etc.

The baking temperature can be lowered by adding glass such as lead borosilicate glass or other compounds of low melting points (e.g., bismuth oxide) to the piezoelectric/electrostrictive/ceramics. The lowered baking temperature is advantageous in forming the emitter section 12 on the mother board 102.

If the emitter section 12 is made of a material having a high melting point or a high evaporation temperature, such as a non-lead material, then it is resistant to damage caused by collision with electrons or ions.

The emitter section 12 may be formed on the mother board 102 or the module board 112 by any of various thick-film forming processes including screen printing, dipping, application, electrophoresis, or any various thin-film forming processes including an ion beam process, sputtering, vacuum evaporation, ion plating, chemical vapor deposition (CVD), plating.

In the present embodiments, the emitter section 12 is preferably formed on the mother board 102 or the module board 112 by any various thick-film forming processes including screen printing, dipping, application, electrophoresis.

These thick-film forming processes allow the emitter section 12 to be formed using a paste, a slurry, or a suspension, an emulsion, or a sol which is mainly composed of particles of piezoelectric ceramics having an average particle diameter ranging from 0.01 to 5 μm, preferably from 0.05 to 3 μm, and high piezoelectric properties can be achieved by the emitter section 12 thus formed.

Especially, the electrophoresis process is capable of forming films at a high density to a high shape accuracy, and also has such features as described in “Electrochemistry”, Vol. 53, No. 1 (1985), pages 63-68, written by Kazuo Anzai, and “The 1^{st} Meeting on Finely Controlled Forming of Ceramics Using Electrophoretic Deposition Method”, collected abstracts (1998), pages 5-6, pages 23-24. A piezoelectric/electrostrictive layer or an anti-ferroelectric layer which is formed as a sheet, or a laminated assembly of piezoelectric/electrostrictive layers or anti-ferroelectric layers, or a piezoelectric/electrostrictive layer or an anti-ferroelectric layer that is stacked on or bonded to a supporting board may be employed. The process to be employed should be selected in view of the required accuracy and reliability.

The cathode electrode 14 is made of materials to be described below. The cathode electrode 14 should preferably be made of a conductor having a small sputtering yield and a high evaporation temperature in vacuum. For example, materials having a sputtering yield of 2.0 or less at 600 V in Ar⁺, and an evaporation pressure of 1.3×10⁻³ Pa at a temperature of 1800 K or higher, are preferable. Such materials include platinum, molybdenum, tungsten. The cathode electrode 14 may be made of a conductor which is resistant to a high-temperature oxidizing atmosphere, e.g., a metal, an alloy, a mixture of insulative ceramics and a metal, or a mixture of insulative ceramics and an alloy. Preferably, the cathode electrode 14 should be chiefly composed of a precious metal having a high melting point, such as platinum, iridium, palladium, rhodium, molybdenum, or an alloy of silver and palladium, silver and platinum, platinum and palladium, or the like, or a cermet of platinum and ceramics. Further preferably, the cathode electrode 14 should be made only of platinum, or a material chiefly composed of a platinum-base alloy. The cathode electrode 14 should also preferably be made of carbon or a graphite-base material, e.g., diamond thin film, diamond-like carbon, or carbon nanotube. Ceramics to be added to the electrode material should preferably have a proportion ranging from 5 to 30 volume %.

Furthermore, a material such as an organic metal paste which can produce a thin film after being baked, e.g., a platinum resinate paste or the like, should preferably be used. An oxide electrode for suppressing a polarization inversion fatigue, which is made of ruthenium oxide, iridium oxide, strontium ruthenate, La₁₋ₓSrₓCoO₃ (e.g., x=0.3 or 0.5), La₁₋ₓCaₓMnO₃, La₁₋ₓCaₓMn_{1-y}Co_{y}O₃ (e.g., x=0.2, y=0.05), or a mixture of any one of these compounds and a platinum resinate paste, for example, is preferable.

The cathode electrode 14 may be made of any of the above materials by any various thick-film forming processes including screen printing, spray coating, dipping, coating, application, electrophoresis, or any various thin-film forming processes including sputtering, an ion beam process, vacuum evaporation, ion plating, chemical vapor deposition (CVD), plating. Preferably, the cathode electrode 14 is made by any of the above thick-film forming processes.

The anode electrode 18 is made of the same material by the same process as the cathode electrode 14. Preferably, the anode electrode 18 is made by any of the above thick-film forming processes.

The mother board 102 and the module board 112 should preferably be made of an electrically insulating material because interconnections electrically connected to the cathode electrodes 14 and interconnections electrically connected to the anode electrodes 18 are electrically isolated.

Therefore, the mother board 102 and the module board 112 may be made of glass, or a highly heat-resistant metal or a material such as an enameled material where a surface of such a highly heat-resistant metal is covered with a ceramic material such as glass. However, ceramics is most favorable as the material of the mother board 102 and the module board 112.

The ceramics of the mother board 102 and the module board 112 may be stabilized zirconium oxide, aluminum oxide, magnesium oxide, titanium oxide, spinel, mullite, aluminum nitride, silicon nitride, glass, or a mixture thereof. Aluminum oxide and stabilized zirconium oxide are particularly preferable because they provide high mechanical strength and high tenacity. Stabilized zirconium oxide is particularly preferable because it has relatively high mechanical strength, relatively high tenacity, and causes a relatively small chemical reaction with the cathode electrodes 14 and the anode electrodes 18. Stabilized zirconium oxide includes both stabilized zirconium oxide and partially stabilized zirconium oxide. Stabilized zirconium oxide does not cause a phase transition because it has a crystalline structure such as a cubic structure.

Zirconium oxide causes a phase transition between a monoclinic structure and a tetragonal structure at about 1000° C., and upon such a phase transition, the zirconium oxide may crack. Stabilized zirconium oxide contains 1 to 30 mol % of a stabilizer such as calcium oxide, magnesium oxide, yttrium oxide, scandium oxide, ytterbium oxide, cerium oxide, or an oxide of a rare earth metal. The stabilizer should preferably contain yttrium oxide in order to increase the mechanical strength of the mother board 102. If stabilized zirconium oxide contains yttrium oxide, then it should preferably contain 1.5 to 6 mol % of yttrium oxide, or more preferably 2 to 4 mol % of yttrium oxide, and furthermore, should preferably contain 0.1 to 5 mol % of aluminum oxide.

The crystalline phase of stabilized zirconium oxide may be a mixture of cubic and monoclinic systems, a mixture of tetragonal and monoclinic systems, or a mixture of cubic, tetragonal and monoclinic systems. Particularly, it is most preferable from the standpoint of strength, tenacity, and durability that the crystalline phase contained chiefly is a tetragonal system or a mixture of tetragonal and cubic systems.

If the mother board 102 and the module board 112 are made of ceramics, then they are constructed of relatively many crystal grains. In order to increase the mechanical strength of the mother board 102 and the module board 112, the average diameter of the crystal grains should preferably be in the range from 0.05 to 2 μm and more preferably in the range from 0.1 to 1 μm.

Each time the emitter section 12, the cathode electrode 14, or the anode electrode 18 is formed, the assembly may be heated (sintered) into a structure that is integral with the mother board 102 and the module board 112. After the emitter section 12, the cathode electrode 14, and the anode electrode 18 is formed, they may simultaneously be baked so as to be integrally coupled to the mother board 102 and the module board 112. Depending on the process by which the cathode electrode 14 and the anode electrode 18 are formed, they may not be heated (sintered) to be combined.

The sintering process for combining the emitter section 12, the cathode electrode 14, and the anode electrode 18 with the mother board 102 and the module board 112 may be carried out at a temperature ranging from 500° to 1400° C., preferably from 1000° to 1400° C. For heating the emitter section 12 which is in the form of a film, the emitter section 12 should be sintered together with its evaporation source while their atmosphere is being controlled, so that the composition of the emitter section 12 will not become unstable at the high temperature.

The emitter section 12 may be covered with an appropriate member for concealing the surface against direct exposure to the sintering atmosphere when the emitter 14 is sintered. The covering member may be made of the same material as the mother board 102 and the module board 112.

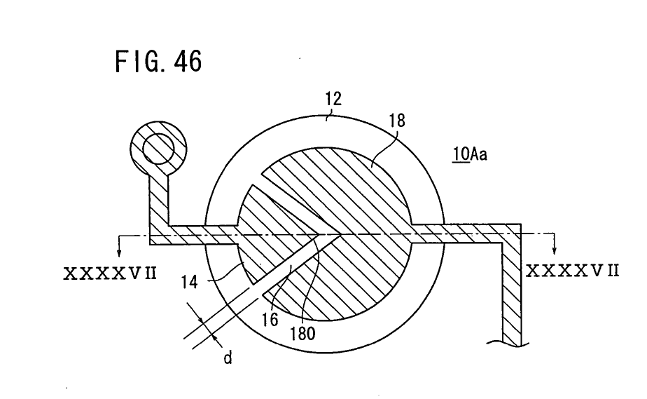

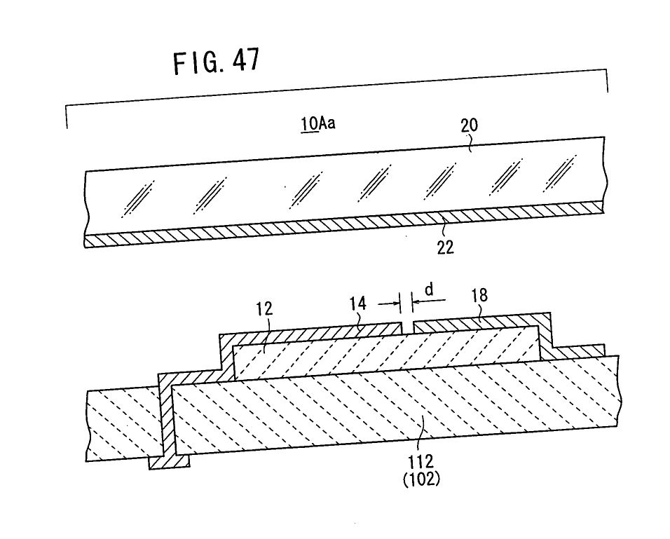

FIGS. 46 and 47 show an electron emitter 10Aa according to a first modification of the electron emitter 10A. The electron emitter 10Aa has a cathode electrode 14 including a sharp corner 180 facing and surrounded by an anode electrode 18. A slit 16 defined between the cathode electrode 14 and the anode electrode 18 should have a width d of 500 μm or less for emitting electrons efficiently.

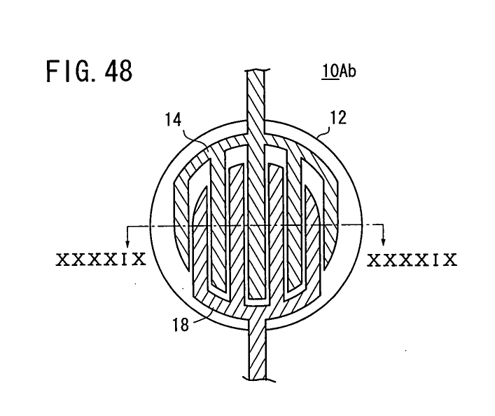

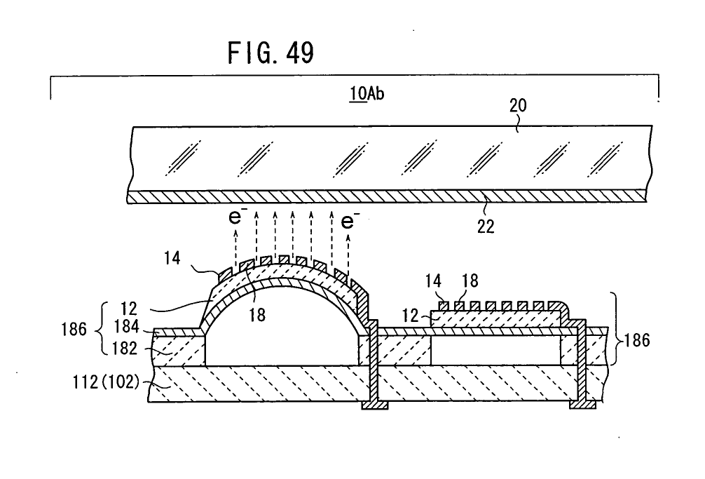

FIGS. 48 and 49 show an electron emitter 10Ab according to a second modification of the electron emitter 10A. The electron emitter 10Ab has an emitter section 12 made of an anti-ferroelectric material, and a cathode electrode 14 and an anode electrode 18, each of a comb-shape, disposed on one surface of the emitter section 12.

As shown in FIG. 49, the electron emitter 10Ab is disposed on a sheet layer 184 mounted on a spacer layer 182 which is disposed on the mother board 102 or the module board 112. The emitter section 12, the cathode electrode 14, the anode electrode 18, the sheet layer 184, and the spacer layer 182 jointly make up an actuator 186.

If the emitter section 12 comprises an anti-ferroelectric layer, then it should preferably made of a material containing lead zirconate, a material containing lead zirconate and lead stannate as a chief component, a material containing lead zirconate with lanthanum oxide added thereto, or a material containing a component of lead zirconate and lead stannate with lead zirconate and lead niobate added thereto. For driving the electron emitter 10Ab, it is preferable to employ an anti-ferroelectric material containing a component of lead zirconate and lead stannate having the following composition:

Pb_{0.99}Nb_{0.02}[(ZrₓSn₁₋ₓ)_{1-y}Ti_{y}]0.98O₃

where 0.5<x<0.6, 0.05<y<0.063, 0.01<Nb<0.03.

The anti-ferroelectric material may be porous. If the anti-ferroelectric material is porous, then the porosity should preferably be 30% or less.

The emitter section 12 should preferably be formed by any of the various thick-film forming processes described above. Particularly, the screen printing is preferable because it can produce fine printed patterns. The emitter section 12 should preferably have a thickness of 50 μm or less, or more preferably a thickness in the range from 3 to 40 μm, for achieving a large displacement under a low drive voltage.

According to the above thick-film forming process, the emitter section 12 can be formed as a film on the surface of the sheet layer 184 from a paste or slurry that is chiefly composed of ceramic particles of an anti-ferroelectric material having an average diameter ranging from 0.01 to 7 μm, preferably from 0.05 to 5 μm, for high device characteristics.

The sheet layer 184 is thin and has a structure susceptible to vibrations under external stresses. Preferably, the sheet layer 184 is made of a material that is highly resistant to heat. The reasons for making the sheet layer 184 of a highly heat-resistant material are as follows: If a structure is employed in which the sheet layer 184 is directly supported in directly joining terminals to the sheet layer 184 without using a material which is low in heat resistance, such as an organic adhesive, then the sheet layer 184 made of a highly heat-resistant material is prevented from being modified when the emitter section 12 is formed. If the sheet layer 184 is made of ceramics, then it should preferably be made of the same material as the mother board 102 and the module board 112.

Preferably, the spacer layer 182 is made of ceramics. The spacer layer 182 may be made of the same material as the sheet layer 184, or may be made of a ceramic material different from the sheet layer 184. As with the ceramic material of the sheet layer 184, the ceramics of the spacer layer 182 may be stabilized zirconium oxide, aluminum oxide, magnesium oxide, titanium oxide, spinel, mullite, aluminum nitride, silicon nitride, glass, or a mixture thereof.

Ceramic materials different from the ceramic material of the mother board 102, the module board 112, the spacer layer 182, and the sheet layer 184 should preferably include a material chiefly containing zirconium oxide or aluminum oxide, or a mixture thereof. Particularly, a material chiefly containing zirconium oxide is most preferable.

Clay or the like may be added as a sintering additive. Additive components need to be adjusted so that materials easily vitrified, such as silicon oxide, boron oxide are not excessively contained. These easily vitrifiable materials are advantageous from the standpoint of making a strong joint with the emitter section 12, but these materials promote a reaction with the emitter section 12. Thus, these materials make it difficult to keep a desired composition of the emitter section 12, resulting in poor device characteristics.

Specifically, silicon oxide contained in the mother board 102, the module board 112, the spacer layer 182, and the sheet layer 184 should be limited to 3 weight % or less, or preferably 1 weight % or less. The component which is chiefly contained in the material described above refers to a component which is present in 50 weight % or more.

It is preferable to assemble the mother board 102, the module board 112, the spacer layer 182, and the sheet layer 184 as a three-layer laminated assembly. These layers are simultaneously sintered integrally, or joined or attached together by glass or resin. The mother board 102, the module board 112, the spacer layer 182, and the sheet layer 184 may be assembled in four or more layers.

If the emitter section 12 is made of an anti-ferroelectric material, when no electric field is applied to the emitter section 12, it is flat, as indicated by the right-side emitter section 12 in FIG. 49. When an electric field is applied to the emitter section 12, it is bent into a convex shape as indicated by the left-side emitter section 12 in FIG. 49. When the emitter section 12 is bent into a convex shape, the gap between the electron emitter 10Ab and the collector electrode 22 which faces the electron emitter 10Ab is reduced, allowing emitted electrons to move more linearly as indicated by the broken-line arrows. It is thus possible to control the amount of emitted electrons that reach the collector electrode 22 based on the extent to which the emitter section 12 is bent.

The displays 100A through 100D described above offer the following advantages:

(1) The displays can be much thinner (the panel thickness=several mm) than CRTs.

(2) Since the displays emit natural light from the phosphor layer 106, they can provide a wide angle of view which is about 180°, unlike LCDs (liquid crystal displays) and LEDs (light-emitting diodes).

(3) Since the displays employ a surface-electron source, they produce less image distortions than CRTs.

(4) The displays can respond more quickly than LCDs, and can display moving images free of after image with a high-speed response on the order of μsec.

(5) The displays consume an electric power of about 100 W in terms of a 40-inch size display, and hence, its power consumption is lower than CRTs, PDPs (plasma displays), LCDs, and LEDs.

(6) The displays have a wider operating temperature range (−40° to +85° C.) than PDPs and LCDs. Further, LCDs have lower response speeds at lower temperatures.

(7) The displays can produce higher luminance than conventional FED displays as the phosphor can be excited by a large current output.

(8) The displays can be driven at a lower voltage than conventional FED displays because the drive voltage can be controlled by the polarization reversal characteristics and film thickness of the piezoelectric material.

Because of the above various advantages, the displays can be used in a variety of applications described below.

(1) Since the displays can produce higher luminance and consume lower electric power, they are optimum for use as 30- through 60-inch displays for domestic use (television and home theaters) and public use (waiting rooms, karaoke rooms).

(2) Inasmuch as the displays can produce higher luminance, provide large screen sizes, display full-color images, and display high-definition (high-resolution) images, they are optimum for use as horizontally or vertically long, irregularly shaped displays, displays in exhibitions, and message boards for information guides.

(3) Because the displays can provide a wider angle of view due to higher luminance and fluorescent excitation, and can be operated in a wider operating temperature range due to vacuum modularization, they are optimum for use as displays on vehicles. Displays for use on vehicles need to have a horizontally long 8-inch size whose horizontal and vertical lengths have a ratio of 15:9 (pixel pitch=0.14 mm), an operating temperature in the range from −300 to +85° C., and a luminance level ranging from 500 to 600 cd/m² in an oblique direction.

Because of the above various advantages, the displays can be used as a variety of light sources described below.

(1) Since the displays can produce higher luminance and consume lower electric power, they are optimum for use as projector light sources which are required to have a luminance level of 2000 lumens.

(2) Because the displays can easily provide a high-luminance two-dimensional array light source, can be operated in a wide temperature range, and can provide constant light emission efficiency outdoors, they are a promising alternative of LEDs. For example, the displays are optimum as an alternative of two-dimensional array LED modules for traffic signal devices. At 25° C. or higher, the allowable current of LEDs is lowered, and produce low luminance.

Although certain preferred embodiments of the present invention have been shown and described in detail, it should be understood that various changes and modifications may be made therein without departing from the scope of the appended claims.

What is claimed is:

1. A display comprising:
a housing having a first board; and
a plurality of modules each having a plurality of electron emitters arrayed on a second board;
said modules being arrayed on said first board;
at least said modules being electrically connected to each other;
said modules being sealed in vacuum in said housing.

2. A display according to claim 1, wherein said housing has a transparent plate facing said first board, said transparent plate supporting, on a surface thereof facing said first board, an electrode for producing an electric field between the electrode and said electron emitters, and a phosphor disposed on said electrode, and wherein electrons emitted from said electron emitters impinge on said phosphor to excite the phosphor for thereby emitting light therefrom.

3. A display according to claim 1, wherein each of said electron emitters comprises:
an emitter section made of a dielectric material; and
a first electrode and a second electrode which are disposed in contact with said emitter section;
and wherein when a drive voltage is applied between said first electrode and said second electrode, at least a portion of said emitter section has a polarization reversed or changed to emit electrons therefrom.

4. A display according to claim 3, wherein said first electrode and said second electrode are disposed in contact with a principal surface of said emitter section, with a slit defined between said first electrode and said second electrode, said emitter section being partly exposed through said slit.

5. A display according to claim 3, wherein said first electrode is disposed on a first surface of said emitter section, and said second electrode is disposed on a second surface of said emitter section.

6. A display according to claim 3, wherein said emitter section is made of at least one of a piezoelectric material, an electrostrictive material, or an anti-ferroelectric material.

7. A display comprising:
a housing having a first board; and
a plurality of chips each having an electron emitter;
said chips being arrayed on said first board;
at least said chips being electrically connected to each other;
said chips being sealed in vacuum in said housing.

8. A display according to claim 7, wherein said housing has a transparent plate facing said first board, said transparent plate supporting, on a surface thereof facing said first board, an electrode for producing an electric field between the electrode and said electron emitters, and a phosphor disposed on said electrode, and wherein electrons emitted from said electron emitters impinge on said phosphor to excite the phosphor for thereby emitting light therefrom.

9. A display according to claim 7, wherein each of said electron emitters comprises:
an emitter section made of a dielectric material; and
a first electrode and a second electrode which are disposed in contact with said emitter section;
and wherein when a drive voltage is applied between said first electrode and said second electrode, at least a portion of said emitter section has a polarization reversed or changed to emit electrons therefrom.

10. A display according to claim 9, wherein said first electrode and said second electrode are disposed in contact with a principal surface of said emitter section, with a slit defined between said first electrode and said second electrode, said emitter section being partly exposed through said slit.

11. A display according to claim 9, wherein said first electrode is disposed on a first surface of said emitter section, and said second electrode is disposed on a second surface of said emitter section.

12. A display according to claim 9, wherein said emitter section is made of at least one of a piezoelectric material, an electrostrictive material, or an anti-ferroelectric material.

13. A display comprising:
a housing having a first board; and
a plurality of electron emitters directly formed as a film on said first board;
said electron emitters being sealed in vacuum in said housing.

14. A display according to claim 13, wherein said housing has a transparent plate facing said first board, said transparent plate supporting, on a surface thereof facing said first board, an electrode for producing an electric field between the electrode and said electron emitters, and a phosphor disposed on said electrode, and wherein electrons emitted from said electron emitters impinge on said phosphor to excite the phosphor for thereby emitting light therefrom.

15. A display according to claim 14, wherein each of said electron emitters comprises:
an emitter section made of a dielectric material; and
a first electrode and a second electrode which are disposed in contact with said emitter section;
and wherein when a drive voltage is applied between said first electrode and said second electrode, at least a portion of said emitter section has a polarization reversed or changed to emit electrons therefrom.

16. A display according to claim 14, wherein said first electrode and said second electrode are disposed in contact with a principal surface of said emitter section, with a slit defined between said first electrode and said second electrode, said emitter section being partly exposed through said slit.

17. A display according to claim 14, wherein said first electrode is disposed on a first surface of said emitter section, and said second electrode is disposed on a second surface of said emitter section.

18. A display according to claim 14, wherein said emitter section is made of at least one of a piezoelectric material, an electrostrictive material, or an anti-ferroelectric material.

19. A display comprising:
a housing having a first board; and
a plurality of vacuum-sealed modules each having a plurality of electron emitters arrayed on a second board and sealed in vacuum;
said vacuum-sealed modules being arrayed on said first board;
at least said vacuum-sealed modules being electrically connected to each other.

20. A display according to claim 19, wherein each of said vacuum-sealed modules has a transparent plate facing said second board, said transparent plate supporting, on a surface thereof facing said second board, an electrode for producing an electric field between the electrode and said electron emitters, and a phosphor disposed on said electrode, and wherein electrons emitted from said electron emitters impinge on said phosphor to excite the phosphor for thereby emitting light therefrom.

21. A display according to claim 19, wherein each of said electron emitters comprises:
an emitter section made of a dielectric material; and
a first electrode and a second electrode which are disposed in contact with said emitter section;
and wherein when a drive voltage is applied between said first electrode and said second electrode, at least a portion of said emitter section has a polarization reversed or changed to emit electrons therefrom.

22. A display according to claim 21, wherein said first electrode and said second electrode are disposed in contact with a principal surface of said emitter section, with a slit defined between said first electrode and said second electrode, said emitter section being partly exposed through said slit.

23. A display according to claim 21, wherein said first electrode is disposed on a first surface of said emitter section, and said second electrode is disposed on a second surface of said emitter section.

24. A display according to claim 21, wherein said emitter section is made of at least one of a piezoelectric material, an electrostrictive material, or an anti-ferroelectric material.
